(19) United States
(12) Patent Application Publication
(10) Pub. No.: US 2020/0288895 A1
(43) Pub. Date: Sep. 17, 2020

(54) Drone Drop System Supporting Delivery Management

(71) Applicants: James Duane Bennet, Hroznetin (CZ); Bindu Rama Rao, Laguna Niguel, CA (US)

(72) Inventors: James Duane Bennet, Hroznetin (CZ); Bindu Rama Rao, Laguna Niguel, CA (US)

(21) Appl. No.: 16/354,132

(22) Filed: Mar. 14, 2019

(51) Int. Cl. A47G 29/14; H04W 12/00; G06Q 50/28

(52) U.S. Cl. CPC A47G 29/141; H04N 7/183; G06Q 50/28; H04W 12/001

(57) ABSTRACT

A secure drop box comprises a processing circuitry that directs the container portion of the secure drop box containing the delivery item to open up for easy withdrawal of the item. The secure drop box directs the drone to approach it along a predetermined path. The secure drop box communicates a notification indicating receipt of the delivery item when the drone has delivered the item into the secure drop box. The notification comprises a digital image taken by a camera disposed inside or on top of the container portion of the secure drop box. The processing circuitry directs the drone to deliver the delivery item at an alternate drop box when the secure drop box is determined to already contain a previously delivered item.

### CROSS REFERENCES TO RELATED APPLICATIONS

### BACKGROUND

### 1. Technical Field

The present invention relates generally to drone based delivery, and more specifically to delivery management of drones that deliver into drone drop boxes.

### 2. Related Art

Several types of drone based systems exist, some for commercial and military purposes but most being deployed for entertainment such as “selfie” camera drones, childrens' toys, etc. Regarding military purposes, drones are now commonly participating in bombing, monitoring individual and troop movements, and so on. For commercial purposes, some drone bases systems have been designed for remote monitoring of land, sea, utilities and buildings. Experimental delivery drone systems, for example, to deliver food, mail and small packages, have been mentioned in the media.

There are many complications that have been identified with drone flight. For example, unauthorized snooping of neighbors, interference with airplane flight, and collisions have been identified. Regarding delivery, many conventional troubles exist such as dropped package theft, wrong address deliveries and attempts, dropped package/item exposure to weather, recipient not at home, etc.

There are many complications in drone-based delivery. Where does the drone make a delivery? How do we ensure the right person gets it? How do we know the delivery has been made? How does the sender get to know if the attempt to deliver succeeded? How does the receiver specify where he wants it delivered? What are the means by which one could make drone based security foolproof, accountable, reliable and safe?

Where to deliver items is a tough problem to solve. How to deliver is another tough problem to solve. Determining when to deliver is also a difficult problem to solve. What to do when delivery is not possible is another set of problems. The present invention addresses these limitations and disadvantages of current drone systems, and some additional ones too.

Further limitations and disadvantages of current drone systems and conventional non-drone delivery approaches will become apparent to one of ordinary skill in the art through comparison with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective diagram illustrating an embodiment of drone drop infrastructure supporting delivery management to a premises wherein various registered drones (such as, for example, a airborne drone and a ground drone) engage in both pickups and deliveries of items at the premises through coordination with various exemplary premises drop systems such as a drop flag, drop bell system, drop tab, integrated drop slot, retractable window drop box, roof height retrievable drop box, pole mount retrievable drop box, drop basket, drop window opener system, and employing phone computing device and a user computer system for communications with a user in the premises;

FIG. 2 is a block diagram illustrating the use of drop boxes in a multi-unit apartment complex wherein a drone delivers products purchased into a user's balcony, into a secure rooftop drop box, into a secure drop box with sliding extension and a container element for storage of items, in accordance with the present invention;

FIG. 3 is a perspective diagram of delivery by drones making deliveries into a drop location located on a balcony or on to a retractable/foldable platform assembled outside the balcony of a building;

FIG. 4 is a block diagram of an exemplary head up display for sender, receiver and central management in a drone based delivery process using drop boxes with beacons that serve as delivery destinations;

FIG. 5 is a diagram of a registered runway (such as a drone superhighway) for drones that run in one direction per a given altitude thereby forming a thin square pipeway for a to- and fro-movement along a delivery path to a given destination;

FIG. 6 is a block diagram of an exemplary drone circuitry built in accordance with the present invention, that comprises a host processing circuitry communicatively coupled to a secure memory and a host memory, wherein the drone circuitry also comprises controlled components module, sensors, a battery and solar power unit and a secure element interface circuitry;

FIG. 7 is a block diagram of an exemplary drop box circuitry built in accordance with the present invention, that comprises a host processing circuitry communicatively coupled to a secure memory and a host memory, wherein the drone circuitry also comprises controlled components module, sensors, a battery and solar power unit and a secure element interface circuitry;

FIG. 8 is a block diagram of an exemplary drop Flag/Tab/IoT circuitry built in accordance with the present invention, that guides drone during delivery, interacts with drones as necessary, enforces access security if necessary, monitors traffic and reports problems;

FIG. 9 is a block diagram of an exemplary persistent wireless tag circuitry built in accordance with the present invention, that comprises a host processing circuitry communicatively coupled to a secure memory and a host memory, wherein the persistent wireless tag circuitry also comprises controlled components module, sensors, a battery and solar power unit and a secure element interface circuitry;

FIG. 10 is a perspective block diagram of a delivery drone that docks with charging stations as necessary to recharge its batteries and complete its delivery mission;

FIG. 11 is a perspective diagram of a drone system wherein the effects of drones getting too close to users or to equipment in user premises thereby endangering them is alleviated by the use of longer and retractable tethers to lower packages to their drop spots respectively;

FIG. 12 is a perspective diagram of a drone based delivery system that involves not only delivery aided by aerial drones but also ground based mobile drones, that facilitates not only delivery into staging areas, people's residences but also into drop baskets and adhoc destinations specified by a user using his tablet (using a delivery app for example);

FIG. 13 is a perspective diagram of a communal drop box delivery and secure pickup configuration wherein secure multi delivery box modules each with a digital user interface make it possible to provide convenient centralized delivery solutions in each neighborhood; and

FIG. 14 is a perspective diagram of a premises that supports mobile drones (land drone) based deliveries, kerbside human deliveries into drop boxes, and airborne drone based deliveries into drop boxes, balconies and secure baskets, etc.;

FIG. 15 is a perspective diagram of a premises that supports human deliveries of a package by a human delivery man, a flying air drone based delivery of packages into drop boxes etc. as well as delivery by a mobile truck wherein a user in the premises is prompted to come to the curbside 1561 to pick up a package brought by the mobile truck.

### DETAILED DESCRIPTION OF THE DRAWINGS

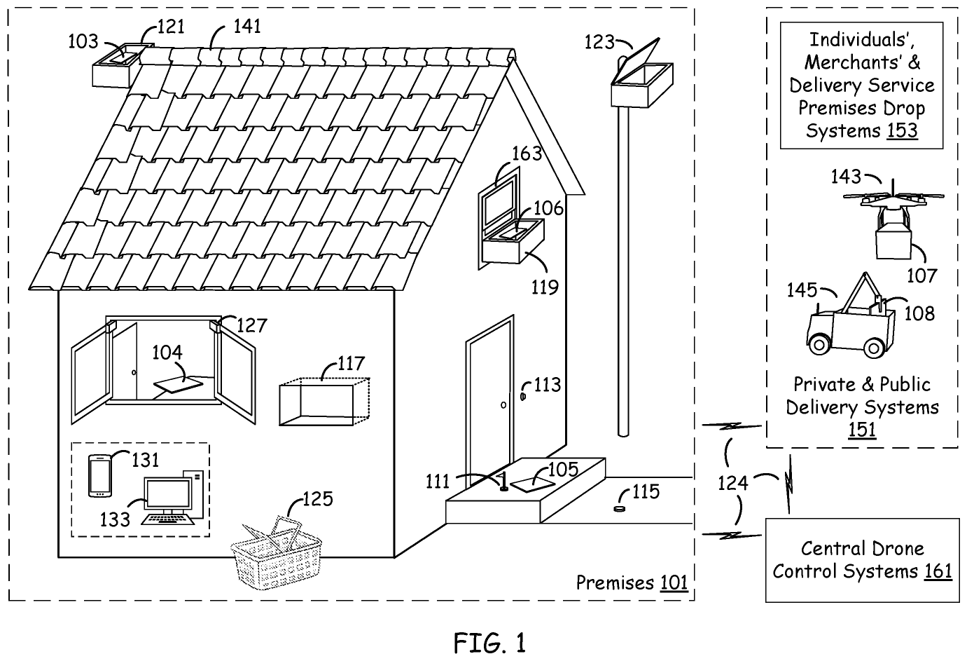

FIG. 1 is a perspective diagram illustrating an embodiment of drone drop infrastructure supporting delivery management to a premises 101 wherein various registered drones 107, 108 (such as, for example, a airborne drone 107 and a ground drone 108) engage in both pickups and deliveries of items at the premises 101 through coordination with various exemplary premises drop systems such as a drop flag 111, drop bell system 113, drop tab 115, integrated drop slot 117, retractable window drop box 119, roof height retrievable drop box 121, pole mount retrievable drop box 123, drop basket 125, drop window opener system 127, and employing phone computing device 131 and a user computer system 133 for communications with a user in the premises.

The various premises drop systems can be referred to as delivery drop box systems or delivery drop box networks, and make use of one or more delivery and pickup devices available in the premises e.g., the integrated drop slot 117, the retractable window drop box 119, the roof height retrievable drop box 121, the pole mount retrievable drop box 123, and the drop basket 125 are all various optional components of a such a system. These delivery and pickup devices available in the premises typically comprise a container element configured to both accept a delivery item and secure the delivery item after the acceptance, a wireless communication circuitry configured to support secure communication with the drone 143 and a processing circuitry. The processing circuitry, after evaluating the secure communication with the drone 143 to confirm delivery authorization, directs the container element to accept the delivery item from the drone 143, and, after receiving the delivery item, the processing circuitry directs the securing of the delivery item by the container element. In some configurations, they also comprise a touch sensitive display unit for user interactions (for example for accepting security codes, for verification of users, for display of transaction details, for displaying product/item details, etc.)

Depending on the configuration, premises drop systems may also include various drop-off and pick-up locationing support elements whether or not they comprise such containers. These premises drop systems may be referred to as drop locationing systems. Examples of drop locationing systems include all of the drop box systems identified above plus the drop window opener system 127, the drop flag 111, the drop tab 115 and the drop bell system 113. Premises drop systems may also include pick-up and drop-off security and confirmation elements. If so, these premises drop systems may be referred to as drop support systems or delivery accessories.

In one configuration, a delivery drop box 123, 119 that supports deliveries made by a drone 143 makes it possible to send off packages for delivery to other places/users, as well as receive packages from senders, etc. The delivery drop box 123, 119 comprises a container element configured to both accept a delivery item and secure the delivery item after the acceptance, a wireless communication circuitry (not shown) configured to support secure communication with the drone 143 and a processing circuitry. The processing circuitry (not shown), after evaluating the secure communication with the drone 143 to confirm delivery authorization, directs the container element to accept the delivery item from the drone 143, and, after receiving the delivery item, the processing circuitry directs the securing of the delivery item by the container element.

Pick-ups and deliveries of items are managed by individuals (for example sending an item to a friend) or between merchants and their customers. More specifically, exchanges between an individual' merchants' delivery premises drop systems 153 and premises drop systems of the premises 101 (not shown) may be carried out using private and public delivery systems 151, but such deliveries must be cleared, monitored and verified by central drone control systems 161. Thus the senders and receivers are serviced by the private and public delivery systems 151, such as a UBER baser delivery system for example.

A central drone control system 161 manages drone registration, enforces laws and rule based drone behavior and pathway restrictions, forces downing or parking of drones when necessary, supports servicing guidance, and collects drone data regarding delivery pathways, confirmations and events.

For example, within the premises drop systems 153, an individual sender may decide to use a private (personal) drone to make a delivery to a receiver friend living at the premises 101. In this example, the airborne drone 143 of the sender needs to be registered with the central drone control systems 161 before it may be permitted to depart the sender's premises. If registered, the individual sender interacts, for example via a software application (“App”) running on their cell phone131, with the central drone control systems 161 by identifying the airborne drone 143 (e.g., registration number), providing security log in data, identifying payload weight and item category, providing source and destination addresses, and may even identify a requested delivery pathway or portions thereof. In return, an authorized departure time is granted (which may be immediately, anytime, or at a fixed departure time window) along with a round trip delivery pathway data set (which may or may not include all or a portion of the requested delivery pathway if any happened to be provided). The pathway data set includes: pathway routes and speed limit and altitude limitations along all or portions of the delivery route; required delivery drone to other drone, pedestrian, objects, etc., spacing constraints and behaviors; security requirements; delivery confirmation procedures, and so on.

Examples of confirmation procedures that may be required by the sender or the central drone control systems 161 may involve a requirement that the airborne drone 143 capture a photo or video of the delivered item placed inside a drop box. For example, the ground drone 143 detects the presence of the drop tab 115 via visual or wireless communication and homes in on the drop tab 115′s location. When in close range, the ground drone 145 lifts and places the item 108 near the drop tab 115 and captures a photo/video to confirm the delivery. The drop tab 115 may include active or passive wireless communication capability where its own registration number is present. Alternatively or in addition, the drop tab 115 may include a 1 or 2 dimensional bar code that can be captured via the photo/video element, i.e., an imager. The drop placement of the item 108 may also be managed by the ground drone 145 so that the text address or 1 or 2 dimensional bar code printed on the item 108 may be easily captured within the photo/video that includes the drop tab 115 and its identifying elements. Another confirmation procedure may be to require human interaction and video/photo capture of the delivery event (successful or unsuccessful attempt at delivery, as the case might be). For example, the ground drone 108 is within 60 seconds of arriving at the destination, either the central drone control systems 161, the drop systems 153, or the ground drone 108 places a phone call or triggers the drone bell system 113 or both. If a human opens the door in response, the ground drone 145 and/or any one or more of the premises drop systems of the premises 101 may participate in recording the delivery event including for example photo, video and audio capture.

Security procedures are also definable by the drop systems 153, drones, premises drop systems of the premises 101, and the central drone control systems 161. For example, for weather protection, drop boxes such as the pole mount retrievable drop box 123 may include locking lids or covers that can only be opened with a secure code that is provided to a drone for example for one time use. Other retractions and openings of other types of drop systems of the premises 101 may be similarly triggered by an authorized pick up or delivery drone. This can be accomplished by an owner of a drop box providing a public key or a one time use key directly to the drop systems 153 for loading into a selected pick-up or delivery drone. Alternatively, for higher security, the central drone control systems 161 may store all keys, codes, tokens and associated rules for each owner and each of their premises drop systems. Likewise, access to drop support systems such as the phone computing device 131, the computer system 133 and the door bell system 113 may be managed by the central drone control systems 161, the drop systems 153 or both, depending on security, confirmation and functionality concerns. If a delivery has been made. Notification of the delivery made in the premises 101 is sent to the phone computing device 131 and to the computer system 133 in one related configuration.

Vandalism and theft are other concerns that can be thwarted and monitored by having image, video, audio captures by all relevant and capable drop systems at any premises as directed that are immediately communicated via wired and wireless communication links and pathways 171. For example, in addition the drop systems under attack, all drop systems of all nearby premises and other drones can be directed to capture data in an impending or ongoing vandalism or theft attempt event. Audio instructions warning the human violator that legal action will be taken and video has and continues to be captured may deter a crime. Such coordinated functionality can even follow the escape pathways of the vandal or thief as they attempt an escape. Police, sender, recipient can also be informed immediately along with location information and so on. This coordinated multi-premises and multi-drop system functionality can be managed in whole or in part via any one or more of the phone computing device 131, the computer system 133, any other premises drone systems, or the drop systems 153. In most configurations though, such coordination is directed at least in part by the central drone control systems 161 which may provide a police interface. Face recognition of a recipient (video/photo being captured by the delivery drone) might also be required before a drop is made to avoid delivery to someone unauthorized to receive. To support this, a resident at the premises 101 might deliver their image to the systems 153 and/or 161, well in advance of deliveries as a registration process or provide their images only for one time use at the time of placing the order. Digital signatures and pin codes for one time use can be similarly managed.

Payment on delivery can also be managed via any one or more of the systems and infrastructure shown in FIG. 1. For example, all or any of the drop systems of the premises 101 might be configured to handle NFC (near field communication) and secure element based credit card transactions with the drones 143 and 145 which act in much the same way as a conventional merchant terminal. Alternatives include employment of the central drone control systems 161 in the process as a middleman in the transaction. That is, the recipient applies prepayment to the central drone control systems 161. Then, after acceptable delivery is confirmed, the central drone control system 161 pays the merchant who made the delivery and possibly the underlying sale of the item within the delivery systems 151. Delivery insurance can also be handled within such a payment flow. Another approach for payment might be where the drop systems 153 of a merchant require payment directly from the phone computing device 131 when its delivery drone arrives but before the drone will make the drop or pickup.

In another example of overall functionality, the drop box 121 is fitted with internal and external cameras to take videos or photos confirming delivery by drones, status of products delivered, and retrieval of delivered items by authorized or unauthorized individuals. A lid or opening in these drop boxes 121 are opened by drones based on security codes communicated and instructions provided by the drone delivering products. Similarly, for retrieval of delivered products, a user is prompted to provide a security code, to provide an audio recognition input, or to provide a facial recognition input, etc. Other forms of user authentication are also contemplated.

In one embodiment, the central drone control systems 161 supporting drone delivery path assignment and adhoc drone delivery path changes is provided to promote on-time delivery of purchased items acquired in online sales transactions in accordance with the present invention. Using the central drone control systems 161, a first user (i.e., a buyer or customer) using a first ordering source device (laptop, TV or mobile device) purchases a plurality of products (such as food, groceries, supplies etc.) with a merchant system of the systems 153. The drone 143 of the merchant delivers the plurality of products purchased, the delivery occurring based on a user designated drop box 121 in the user's premises. For example, the user might have several different drop boxes 119, 121, 123, 125, in his premises, each designated by a different box identification. The user selectively specifies one of the several different drop boxes available to be the target destination for delivery. Alternatively, the user might choose not to specify a specific target destination (drop box 121, for example) for delivery, and let the drone negotiate and identify one of the several different drop boxes 119, 121, 123, 125, in the user's premises as a destination for delivery.

In any given premises, a number of drone drop boxes may be installed as necessary—one in the front 121, another at the back 123, a third one on a balcony window119, etc. A drone approaches one of these drop boxes 121, 123, 119 and determines if it is appropriate for the items being delivered. For example, the drone decides to drop the items in an alternative drop box at that premises if it discovers that the first drop box 121 is full, or is not operational, or incapable of storing/holding the items being delivered. The plurality of drone boxes in a premises communicate with each other, and coordinate activities such as taking photos or videos of delivery events, retrieval events, etc.

A drone tracking infrastructure 151 and/or 161 generates a first delivery task following an online sales transaction conducted by a first user residing at the premises and the drone tracking infrastructure 151 and/or 161 creates a delivery plan for delivery to the user at the requested time. In one configuration, the private & public delivery system 151 is capable of conducting drone tracking. The airborne drone 143 is assigned the task of delivery, and it delivers the purchased items to the first user's premises and takes a confirmation photo/video after the items have been deposited into the drop box 121. If the drop box 121 is discovered to be full, or incapable of accommodating any additional items, the airborne drone 143 determines that an alternate drop box 119 needs to be used for delivery, and it delivers the items into the drop box 119 and takes confirmation videos/photos.

The present invention also makes it possible to employ the services of an unattached/independent movable drop box 125 that is placed by the user/buyer in an open yard or patio to allow the airborne drone 143 to deliver its items.

In some embodiments, each of the drop boxes 119, 121, 123, 125, are fitted with a beacon mechanism that makes them invite the airborne drone 143 to deliver the items inside or in proximity to the corresponding drop boxes. In such a scenario, the user designates one of the drop boxes to be a default or primary delivery destination, and the airborne drone 143 attempts to deliver the purchased items into the default or primary delivery destination. If the airborne drone 143 determines that the default or primary delivery destination drop box is not compatible for a delivery for any reason, it selects one of the other drop boxes based on several factors, including their individual sizes, capacities, proximity to the default or primary delivery destination, ease of approach and their operational status.

The central drone control systems 161 maintains the flight pattern layout information for each of the drones 143, 145 as they are assigned delivery tasks, and conducts central management of the delivery process, track misplaced deliveries, problem areas for deliveries, alternate routes for busy zones, etc. The central drone control systems 161 also aggregates delivery activities across individual drones 143, 145, and coordinates synchronized/scheduled delivery of multiple items purchased from different merchants across different areas in a city, so that they are delivered around the same time frame, or delivered at a user specified convenient time frame.

The central drone control systems 161 aggregates demands of various individual home supplies and groceries, etc. across all homes in a region, and anticipates increased demand for some of these supplies/groceries, and ensures their timely delivery by interacting with the supply chain services associated with those corresponding supplies/groceries. The central drone control systems 161 aggregates drone flight paths, and flight data across thousands of drone deliveries in each month, and employs AI to develop optimum flight paths across homes and between homes that speed up delivery of purchased items to buyers during peak hours.

The drones 143, 145 deliver items to apartment buildings and rooftops too, and drop boxes placed in apartments by the windows 163 or placed on rooftops 141 are used for such deliveries. Such rooftop deliveries in multi-unit dwellings are safer options than placing items by the door or in mailboxes, as only residents are able to get to rooftops of buildings.

The drop box 125 is locked up after it receives the delivery from the airborne drone 143. A user is required to enter a PIN into a keypad provided, or in an mobile app provided, before the user is provided access to the delivered items placed into the drop box 123. The keypad may be placed at the base of the pole and a correct code may not only unlock the box lid but also cause the box to be lowered down the pole automatically for user access. The user is alerted to the availability of purchased items and their successful delivery by the airborne drone 143. To manage security, a one time or limited use token or key code (for lock, unlock and access) can also be employed in any other drop system, such as to open windows (i.e., activating the drop window opening system 127) or the drop basket 125, and can be required to access functionality such as within the drop bell system 113, the phone computing system 131, and the drop tab 115.

In one embodiment, any one or more of the premises drop systems may employ beaconing functionality for identification, capability, status, and guidance support for the drones 143, 145 as they gets close to the premises for delivery. Communication flow from such drop systems of the premises 101 can also communicate via wired and wireless communication links with any component of the systems 151 and 161. Such beacons may be periodically broadcast continuously or only when directed to do so by the systems 161 or 151. Moreover, any of the drones 143 and 145 may also transmit such beacons. Beaconing towers can also be added to the overall infrastructure of the central drone control systems 161 as well that may continuously beacon and require reporting in responses from any one or more of the components illustrated in FIG. 1. For guidance, several beaconing elements can be configured within or in association with a premises drop system of the premises 101 that help carefully guide (for example through triangulation) along with visual data a drone, such as the airborne drone 143, into a second floor inner courtyard drop box of a multi-family building. The beacons employ unique codes such that other users in the neighborhood are unable to illegally or inadvertently obtain deliveries not intended for them. For example, in some configurations, the plurality of beacons in a neighborhood from many different drop systems at many premises allow for coarse locationing (supplementing or confirming GPS locationing) and even fine tuned guidance (e.g., local triangulation) to support any drone based on the beacon signals received. Similarly, a drone can beacon while many receivers on many different drone systems of many different premises can receive and coordinate via timing and communication pathways 124 to identify and calculate the location of the drone. Such location information can be delivered to the drone, other drones and any other component within the premises 101, systems 161 and systems 153.

Drop boxes are assigned weight restrictions and such weight restrictions can be queried by the drones 143, 145 prior to delivery. The systems 161 may attempt to select appropriate drones for the type, size, temperature ranges, fragile nature and weight of a delivery item. The central drone control systems 161 may instead handle this matching or must only reject or authorize a launch of a particular drone if it is well capable of handing the task. Other factors considered include for example lift and current battery range under certain weight loads before authorizing a drone departure. Such requirements may also be associated with certain delivery pathways or require stop over charging, heating or cooling along the way or on the way back. In other words, the central drone control systems 161 may require adequate matching of goods to be delivered with drone capabilities and pathway distances, while also considering traffic congestion. This screening can take place as part of the ordering system wherein some orders might be rejected before payment, where drone delivery can not be sufficiently handled. Also, fairly accurate delivery times based on all of the underlying capabilities and delivery item requirements and sizing/weight can be taken into consideration.

After delivering items to one of the drop boxes within the premises 101, the airborne drone 143 sends alerts to the buyer indicating successful delivery. Such alerts may also be accompanied by videos/photos confirming successful delivery. In addition, the doorbell of the premises can be optionally activated in order to alert any residents to such delivery. In addition, the drop boxes might be made to light up, or lights can be made to flicker indicating availability of delivered items.

An airborne drone 143 that needs servicing will selectively beep to indicate need of servicing. It may also identify deficiencies in battery or item temperature that require temporary docking. A drone that requires servicing may gain a tethered assistant drone or may hand over an item mid delivery to another drone before departing or being picked up for servicing.

In one embodiment, the drop box 119 is a window unit drop box, and, as the airborne drone 143 approaches the window unit drop box 119, a retractable drawer which is by default positioned on the inside of the drop box slides out, so that the drone can deliver its package. After the airborne drone 143 delivers the package the drop box 119 retracts the drawer and shuts the drop box 123. This solution is a weather resistant and secure solution for drone deliveries. Once the drawer is full of received items, no further drone deliveries to this box 119. Drawer space information and present filled or partially filled status is recorded with the systems 161. Authorization for launching further deliveries from any merchant are denied by the systems 161 until the drawer is emptied.

Although not shown, the retractable window drop box (also referred to sometimes as the window mount drop box) 119 may also be configured with a door on its bottom side that opens after the drop box receives delivered items to gently let those items slide to the floor where they settle into a catch basket to leave the drop box free and clear. For example, the window drop box 119 normally is fully retracted into the home to avoid rain and other weather exposure. When a drone such as the drone 143 flies near, a code (key or token) is sent (by the drone 143 or from either of the systems 151 or 161) to open a drawer portion of the box 119. The drawer portion extends to support a cavity for catching a dropped item or exposing an item to be picked up such as the item 106. The drone 143 then either places the item 106 within the cavity or removes the item 106 (if delivery or pickup), captures and delivers an associated video, and signals its completion. Meanwhile, after extending the drawer to expose the cavity, the window drop box 119 videos the drop-off or pick-up event while awaiting the completion signal. Once received, the drawer is retracted into the house for security and weather exposure avoidance. If configured then with a door on the bottom side of the drawer, the window drop box 119 opens that door letting the item 106 slide to a bin within the home under the window (not shown). The door is then closed and the window drop box 119 is ready to receive subsequent deliveries.

In one configuration, a window drop box 119 supporting a delivery of an item by a drone 143 to a building via a window frame makes it convenient and secure to have deliveries made at a user's premises or items picked up by authorized drones for delivering to a another premises/different destination. The window drop box 119 comprises a retractable drawer element sized for mounting within the window frame, the retractable drawer element having both an extended position for receiving the item from a drone 143 outside of a building and a retracted position for holding the item within the building. It also comprises a wireless communication circuitry configured to support secure communication with the drone 143 and a processing circuitry. The processing circuitry, after evaluating the secure communication with the drone 143 to confirm delivery authorization, directs the retractable drawer element to the extended position to receive the item from the drone 143, and, after receiving the item, the processing circuitry directs the retractable drawer element containing the item to the retracted position within the building.

In one configuration of the window drop box 119, the processing circuitry directs the retractable drawer element containing the item to open up for easy withdrawal of the item that has been delivered. The processing circuitry directs the drone 143 to approach it along a predetermined path. The processing circuitry also communicates a notification indicating receipt of the item when the drone 143 has delivered the item. In a related configuration, the notification communicated comprises a digital image taken by a camera disposed inside (or on top of) the retractable drawer element. In addition, the processing circuitry directs the drone 143 to deliver the item at an alternate drop box when the window drop box 119 is determined to already contain a previously delivered item.

In one embodiment, the drop box 121 is elevated on a flag pole such that it can be lowered or raised to remove delivered items or to enable additional deliveries respectively. Raising and lowering can be manual using a rope in much the same fashion as interacting with a flag and flag pole, or employ an automated system complete with key pad or cell phone App activation for security purposes. The box 123 also includes an automated lid for both further security and counter weather exposure of items received or awaiting pickup.

The buyer who expects drone delivery but cannot be present may use the phone computing device 131 to redirect delivery to a willing neighbor. The neighbor can receive a request to accept this responsibility through interacting with the systems 161. In one example, a buyer merely carries the phone computing device 131 to a neighbor's premises and brings it in range of a neighbor's drop box. Interacting through an App on the device 131, the buyer makes a request for a particular incoming delivery. Based on registration information of the neighbor's drop box within the system 161 (or system 153), a request is sent to the neighbor on the neighbors phone which must be accepted before the redirect will be honored. As mentioned, such arrangements are typically facilitated by the central drone control systems 161.

When the airborne drone 143 flies close to the drop window opening system 127 of the premises 101, a code key signal (which may be a one time token) is sent to the system 127 requesting window opening to enable delivery of an item or pickup within the interior of the premises at a convenient spot in the first room encountered. As the window opens, camera based capture of the delivery or pickup request is captured by imagers within both the drone 143 and the system 127. Upon completion, the drone exits via the window and the system 127 closes the window into a locking arrangement, and delivers receipt or pickup video and information to the phone computing device 131, computing system 133, and the systems 161 and 153.

In one embodiment, the airborne drone 143 employs a 3-stage location determination method for deliveries. The user's premises has a first GPS coordinates which is known to a merchant system and the drone tracking infrastructure. Using the first GPS coordinates, the drone approaches the premises. Then when it gets close enough, it receives the beacon signals from one or more drop boxes 121, 123, 119. The airborne drone 143 determines the closest drop box and approaches it for delivering a package. If several beacons respond to the presence of the airborne drone 143 with signals, the airborne drone 143 triangulates using these beacon signals. It them maps its location and the location of the drop box onto an overall map. Thus, low power beacons from around the drop box help autopilot the airborne drone 143 to the drop site.

All or several of the drone systems within the premises 101 and even those located within neighboring premises may be organized into working groups that assists in pickup, drop-offs, security, guidance, confirmation and security functionalities. For example, they can each deliver group beacons and simultaneously video or record delivery and security related functionalities. They can scan for an anticipated drone delivery, and, when one locates an airborne drone 143 in proximity, the overall group can helps guide the airborne drone 143 into an open and available drop box or drop location. For example, all drones in a neighborhood may be required to conduct continuous communication between themselves (on traffic conditions, drop box status, etc.) and optionally incorporate a central controller that services every single drone that has registered with it.

The drop systems of the premises 101 also store and share their locations with the other drop systems of the premises 101, and share such locations with the systems 161 and 151. They also share “Last Known Destinations” of each drone beacon they receive along with time stamp information (for triangulation and route pathway confirmation purposes). The drones 143 and 145 also capture pathway data associated with the entire route and send this data to the systems 153 and 161 in case a drone goes missing or for pathway conformance confirmation. For any drone, a footprint map can be produced on the systems 153 or the computing system 133, for example, along with estimated time of arrival information. It can also be used track down a lost or stolen drone interception during a delivery route and to also find delivery items to the point of its loss/hiding, battery removal or whatever is done to steal items or the associated drone. In addition, airborne drone 143 knockdown and theft is reported when detected, as are failure conditions that cause a drone to land/crash. In a drop basket 125, a camera is placed for taking photos and videos of incoming drones, and a separate camera is placed to image items placed inside the drop basket 125. Such image and video captures are uploaded (e.g., to the systems 161, 153 and 133) for record keeping. In one configuration, such capture and record keeping is triggered only for certain deliveries or pickups or abnormal events such as improper delivery, incomplete delivery, determination of damage to delivered items by the drop box 125 and so on.

Drop boxes can be configured to respond to lid opening (authorized and unauthorized—by force for example) by taking and uploading photos and videos of who has opened it, employing one or more cameras located on its external surfaces. Similarly, the drop boxes detect that one or more items have been placed inside and take photos and videos of items placed inside as part of deliveries by the airborne drone 143.

In addition to NFC, WiFi, Bluetooth, cellular and other radio transceivers, any or all of the drop systems within the premises 101 may also be configured with RF tags and/or RF tag readers. Such RF tags may be placed within delivery and pickup items as well. Any drop systems of any premises may then deploy those transceivers and RF readers, to sniff for stolen or misdelivered items and reported upon detection. For example, a hidden RF tag provided deep within the drop box makes it possible to track its whereabouts and determine if it has been reported as stolen by another user Likewise, a missing drop basket 125 using a Bluetooth beacon might identify itself to a distant drop box which reveals through interaction with the systems 161 that it is stolen. That is, the drop basket 125 and its natural location versus the detected location alone might tip off a theft of the basket 125.

In response to the drop basket 125 being reported or detected as stolen, a theft reporting mode is triggered wherein all drop boxes in the neighborhood or last known location are alerted and instructed to turn their video capture on, such that video data is collected for delivery and processing at a remote server. For example, video recording by all drop boxes in a neighborhood (at least for a duration) can be turned on as soon as an unauthorized access to a drop box 121 is detected, or an intervention to delivery by airborne drone 1435 in an area is detected, and in response, all drop boxes in the neighborhood are placed into a photo mode or video mode in the neighborhood to collect and report data from that neighborhood.

The airborne drone 143 is capable of alerting individuals to stay safe and away from the drone as it delivers a buyer's products. For example, the airborne drone 143 advises “please step back so as not to endanger yourself with my moving parts . . . ”. It then determines if its advise has been followed or not. If its advise on safety are not heeded, it interrupts the current delivery at that premises, takes evasive maneuvers if necessary, and collects photo/video data to report the event. In a related embodiment, delivery by the airborne drone 143 is interrupted or held back until people are absent from a designated drop box 121/drop zone for both safety of people in proximity, for limiting any damage to items delivered, or to prevent possible theft.

Both the airborne drone 143 and ground drone 145 employ intentionally and accidental damage avoidance approaches, and video such events for further and subsequent scrutiny. To accomplish pre-event detection for avoidance, video and audio capture is analyzed. In some configurations, the drones 143 and 145 continuously capture video and in others periodically capture photos. The drones 143 and 145, depending on settings, will either analyze the images/video themselves or enlist the help of the systems 153, 161 or any of the drop systems of a premises such as the premises 101. From this analysis, incoming damage events are recognized and avoidance techniques are deployed. Those include movement adjustments, horn sounds, and audible warning messages. For example, an incoming projectile such as a stone has been detected and evasive measures are triggered along with verbal warnings and video uploading of that event. Typical other incoming damaging events include recognizing an incoming shoe, hand held weapon, and grasping hands are detected. Other damaging events can be detected upon impact which immediately trigger the video and sensor capture, along with uploading, sounding an alert, sending for police or delivery personnel, and possibly delivering warning or assist request words to enlist human assistance.

In one embodiment, all drones 143, 145 need to travel or maintain themselves along a designated route while maintaining a fixed minimum distances between each other, wherein each drone may have a single altitude allocation, or a set of drones are provided an altitude separation allocations. Once an airborne drone 143, using an assigned route at an assigned altitude approaches a designated destination, it drops off the route to maneuver to the exact address. After getting close to the premises, it determines if a drop box 121 is available, and listens to beacons to select one of the drop boxes in proximity.

Route assignments for airborne drones can be laid out to follow telephone pole and telephone line pathways forming a loop along which all drones travel in the same direction within the loop for delivery. For ground drones, bicycle pathways may be preferred for routing flows over even shorter distance sidewalk pathways. Return paths for such drones along a loop may involve assigning a completely different path, or may utilize the same pathway but with higher altitude requirements. Some delivery path loops are dedicated to a particular purpose or company, such as a pizza delivery company, while other delivery path loops, such as those at alternate altitudes or routes, for example, can be shared paths. Government postal service may control optimal pathways during delivery hours then turn such pathways into general food delivery or other dedicated companies such as Amazon after postal delivery hours have ended. Some delivery path loops are assigned based on weight limitations or product category limitations, etc. Drones in such paths are restricted to particular delivery paths based on the items being delivered, and/or the weight or load being carried, or based on size limitations.

As mentioned, communication between airborne drone 143 and drop box 121, or any other drop system, occurs employing one of several possible/available communication protocols, including microwave, line of sight protocols (such as IR), wifi, wimax, bluetoth, 3G, 4G or 5G. Should an airborne drone 143 lose main connectivity, it can use relay connectivity through docking with a drop box 121 or relaying via another drone or other drop system. Drop systems may be connected to networks such as the Internet internally within the building on the premises 101, in addition to or instead of using wireless communication pathways outside of the building.

The central drone control systems 161 tracks abuse of online purchase and delivery services by individuals who frequently order products only to use them for a while only to return them and immediately seeking a refund. The central drone control systems 161 tracks the frequency of returns, the frequency of deliveries, etc. across individuals and neighborhoods. Abuse of the online system, such as a user making too many returns soon after purchase are tracked, and such users are selectively charged a premium for future deliveries. In addition, a delivery insurance is computed and charged to such users.

The opening or interacting with any of the drop systems of the premises 101 may be configured to trigger multiple view confirmation events. For example, the drop box 106 triggers a multiple view confirmation event wherein several different drop systems in proximity, e.g., the box 123 and the drop flag 111, take video and/or photos of the pick up or drop off event. Similarly, the system 127 might respond to the basket 125 lid opening by video capturing the user withdrawing from or placing an item into the drop basket 125. If a drone is also in the vicinity, it also takes a photo/video of the individual retrieving the delivered items. The drop basket 125 can be charged and stored within the building until a delivery or pickup is needed or expected. Then the owner of the basket merely turns the basket 125 to an on status and sets it outside perhaps in his garden, porch or backyard in anticipation of a delivery. If anyone tries to steal the basket, a photo and video is taken and stored by other drop boxes in proximity.

Delivery charges computed for individuals who abuse the online sale and delivery system factors in the risks of misuse or abuse of the services. Such odd buyer behavior is monitored and factored into insurance and delivery charge computation for those associated buyers.

The delivery systems 151 includes a drone rental service and provides a platform for drone rental that allows individuals or organizations to rent drones and have them pickup and deliver items across the city. For example, the airborne drone 143 and ground drone 108 may be rental drones, wherein, for example, a drone rental company provides the airborne drone 143 for a particular delivery or for a pay as you go duration so that it can be used to deliver products for a merchant that needs further drone assistance (doesn't own any or others are engaged) or for private individuals to exchange items. For example, the drone rental service systems within the systems 153, rents an airborne drone 143 and turns over control to an App running on the phone computing device 131. The App then clears (gains authorization and receives flight rules and instructions for the drone 143) a pickup with the central drone control systems 161 to carry a phone book from a friend's home three blocks away to the premises 101. An all day rental might involve a heady duty lifting drone to service pizza parties (multiple boxes per address) all day Saturday for a pizza shop when human deliveries are fully engaged. Deliveries of rental drones can be between merchants, suppliers and individuals in any combination. The central drone control systems 161 may give routing priorities based on item class or characteristic or recipient/sender class or status. Some merchants for example may pay for coveted fast track pathways that they alone use or share with few others based on yearly pathway rental commitments payable to city government coffers. End users may also pay for different levels of service and receive different routing priorities and routes depending on the amount paid in delivery charges.

The central drone control systems 161 also employ rescue drones that have capabilities of lifting a particular disabled drone and its payload. Beyond rescue drones, capture drones are also deployable to counter rogue or potential terror drones. Capture drones may be deployed on detecting rogue drone situations and deploy nets and other elements to force a rogue drone to safety. Beacons on posts throughout a city may also be deployed for the variety of reasons mentioned above from tracking, locationing, security, guidance and confirmation reasons. They may also participate in rogue drone detection, identification and downing. Downing instructions or return-to-base (or return to a target location for inspection) commands must override every user's remote control in every drone registered. Failure to comply triggers a downing or capture. To address dangerous situations in a city such as terror, such city beacon posts can be configured with lasers and projectiles that can damage and take down a rogue drone if necessary. Airborne capture drones may capture both other airborne drones and ground drones, and lift them to heights that minimize danger to humans. Drones may also be directed to drug sniffing dog locations in delivery pathways to thwart illegal use of drones.

Both the central drone control systems 161 and the private and public delivery systems 151 place temporary docking platforms to service private drone fleets and public drones. Such servicing may be free or on a pay for services rendered basis. Such docking platforms may be used for pickup, servicing on the spot by service personnel, for service drone pickups of drones and items, replacement drone item exchanges, item heating and cooling, and for staging of inventory for expected upcoming deliveries (to minimize flight time after order placements) and so on. Temporarily docked drones, for example, may be instructed to visit the docking locations of the systems 161 or 151 for any one or more purposes. It can be built into the delivery plan or be required if a safety, service or other concern arises. The rental rates may vary according to demand or according to the time of day, etc. Similarly, any of the drop systems in the premises 101 or any other premises may be configured to provide such types of docking services. These too may require payment collection if used by a third party wherein the moneys collected are received by the owner of the drone system.

In one embodiment, drop box 125 is a common use pickup boxes, that can be used to drop items delivered to several different houses in the neighborhood baskets in each street where drones 143 drop off items. The delivered items gets locked in the drop box 125 and the corresponding buyer (one who ordered the item for delivery) is sent a special code that allows him/her to unlock the drop box 125 and access the delivered item(s). For example, the buyer gets the special access code on the buyer's mobile phone, so that the buyer can pick up 100 meters away at that general drone drop off box

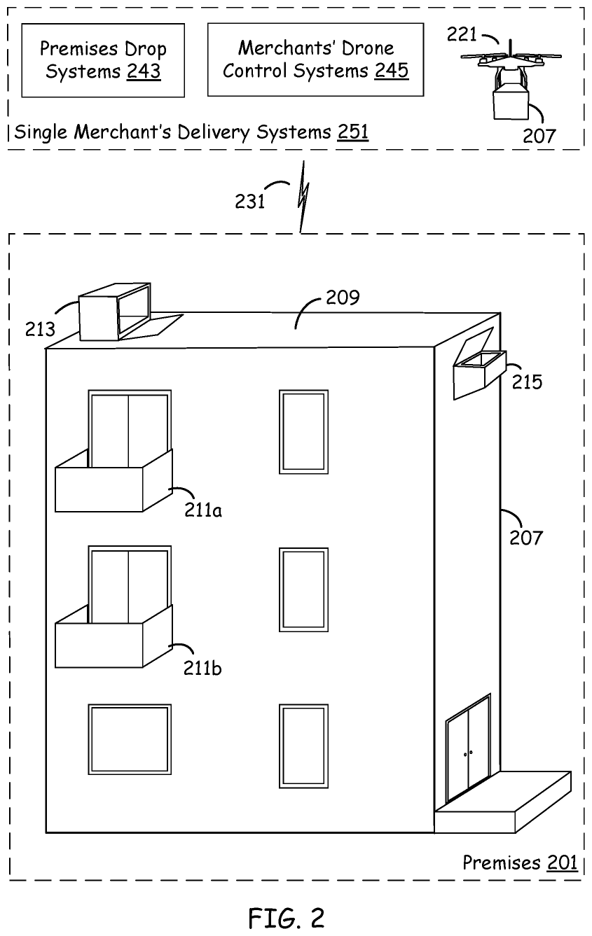

FIG. 2 is a block diagram illustrating the use of drop boxes 213, 215 in a multi-unit apartment complex 207 wherein a drone 221 delivers products purchased into a user's balcony 211(a and b), into a secure rooftop drop box 213, into a secure drop box with sliding extension 215 and a container element for storage of items, in accordance with the present invention. The drones 221 delivers items to apartment buildings such as the multi-unit apartment complex 207, and to and rooftops 209 too. They deliver products to drop boxes placed in apartments by the windows or drop boxes 213 placed on rooftops for such deliveries. Such rooftop deliveries in multi-unit dwellings are safer options than placing items by the door or in mailboxes, as only residents are able to get to rooftops 209 of buildings 207.

The secure drop box with sliding extension 215 slides out from a hidden chamber on the side of the building 207 and opens its delivery opening when triggered by a message or instruction provided by the drone 221 when the drone 221 is in proximity. After the drone 221 has delivered its items, the secure drop box with sliding extension 215 slides back into place closing its previously opened delivery opening. In the closed position, it can be opened on the inside of the building by an authorized user, after the user has presented a security code or satisfied one of the authorization requirements.

Some new houses and buildings have built in shute boxes with rooftop slots into which the drone 221 deposits items. A slow sliding path to an in-house collection point is also provided for ease in picking up the deliveries. Shute boxes that divert deliveries made into user specific delivery boxes within/inside a building are also contemplated.

In one embodiment, drop box 215 is designed as a smart version of a traditional dumb waiter mechanism with a top side that opens to enable delivery of items by drones. After a delivery, the drop box 215 slides down to a designated or specified destination within the building 207 and waits for a user to pick up the deliveries.

In one configuration, a single merchant's delivery systems 251 that comprises a premises drop system 243 and a merchant's drone control system 245 makes it possible to deliver a merchant's items (purchased by buyers) to the buyers who live in premises 201. The premises drop system 243 stores, manages and regularly updates information on various drop boxes in the neighborhood, and the various drop boxes 215, 211, 213 in each multi-living building 207. It knows which of these drop boxes 215, 211, 213 are currently being used and which of these are inoperative, etc. It also tracks a primary and secondary drop locations and drop boxes per premises, per user, per address, as necessary. The merchant's drone control system 245 manages delivery using the drone 221, assignment of delivery paths, assignment of items to be delivered, reassignments of delivery to other drones if necessary, order of items to be picked up and delivered, etc. The merchant's drone control system 245 also maintains inventory of items to be delivered, tracks items already delivered to drop boxes but not yet retrieved by their owners, etc.

Premises 201 comprises several different balconies 211a, 211b and the drone 221 is assigned the right balcony to conduct a delivery. Balcony 211a can be designated as primary drop location by a user with balcony 211b specified as an alternate drop location to be used if for some reason the primary drop location is not accessible or is full.

The secure drop box 215 comprises a processing circuitry that directs the container portion of the secure drop box containing the delivery item to open up for easy withdrawal of the item. The processing circuitry directs the drone 221 to approach it along a predetermined path. The processing circuitry communicates a notification indicating receipt of the delivery item when the drone 221 has delivered the item into the secure drop box 215. The notification comprises a digital image taken by a camera disposed inside or on top of the container portion of the secure drop box 215. The processing circuitry directs the drone 221 to deliver the delivery item at an alternate drop box such as drop box 213 when the secure drop box 215 is determined to already contain a previously delivered item. The processing circuitry informs the drone 221 that it cannot accommodate the delivery item being delivered if the secure drop box 215 is determined to be full or inappropriate for the item being delivered.

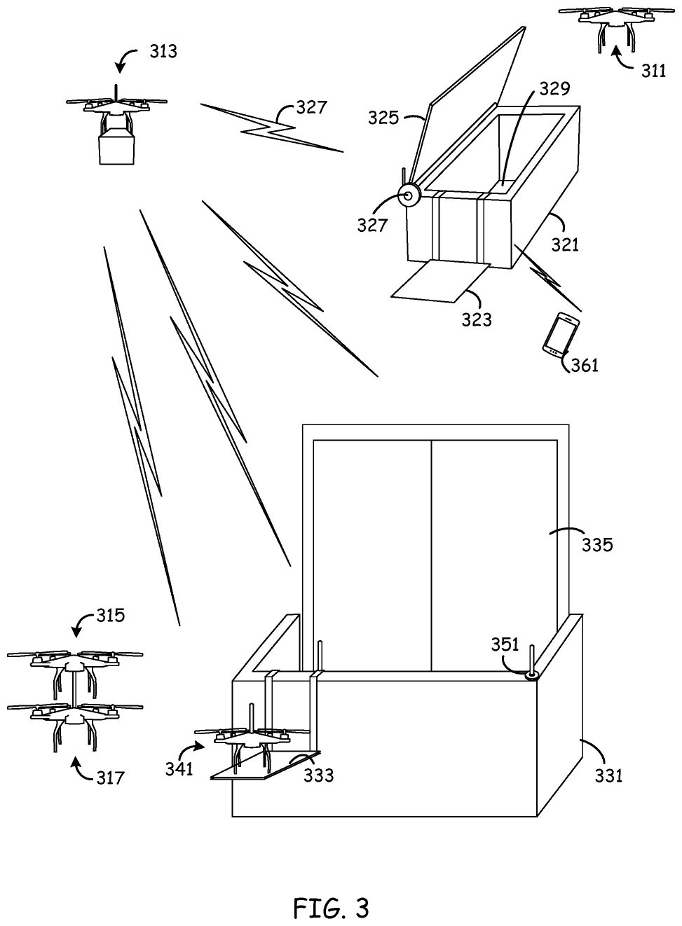

FIG. 3 is a perspective diagram of delivery by drones 311, 313, 315, 317, 341 making deliveries into a drop location 341 located on a balcony 331 or on to a retractable/foldable platform 333 assembled outside the balcony 331 of a building. For example. the drone 313 approaches the balcony 331 employing signals provided by beacons 351, and after approaching the balcony 331, it delivers the item to be delivered onto the balcony 331, placing it just outside the balcony door 335. It then communicates a delivery alert message to the buyer. Alternatively it sends a message that causes a bell of the house (such as a door bell) to ring. Other forms of notification of delivery are also contemplated.

As the drone approaches the balcony 331, if the drone notices the presence of a platform (extended or assembled for the purpose of receiving the delivery items) 333 positioned on the balcony, it places the items to be delivered on that platform, takes a photo/video of the delivery having been made, and communicates it to the buyer along with the delivery alert.

In one configuration, the balcony 331 is fitted with a drop box 321 that comes with a closeable and lockable lid 325. The lid is opened by a signal sent by the drone to the drop box 321. A beacon 327 on the drop box 321 facilitates such delivery. An extendable platform 323 is also provided that attaches to the drop box to facilitate additional deliveries by drones, and also to facilitate a drone station for charging the drone if necessary, for servicing the drone, etc. The extendable platform 323 is a retractable one in one configuration.

Drones 315 and 317 can charge each other in midflight. They can also cooperate in making deliveries, each carrying a subset of the deliveries to be made. In addition, if drone 317 is inoperative or is damaged, drone 315 can pick it up and deliver it to a charging station or to a service station for repairs—appropriate messages and notifications are sent to control stations, managing servers, etc. by the drones 315 and 317 in such activities.

For example, the beacon unit 327 is a motor unit that includes a radio with secure element for direct communication with drones and with a WiFi system at home/premises. It provides short range wireless (e.g., BT or WiFi) communication for drones as well as docked communication for drones 311 when the drones 311 are docked with the platform 323. The beacon unit 327 is also capable in one configuration of communicating via a middleman node(s) such as the sender of the goods to be delivered, or the central drone control system 161 (or in general with central management system) via cellular networks (edge access) and Internet routing (backbone services). The drop box 321 can also communicate toward the user premises elements (e.g., cell phones, in premises WiFi nodes, wired ethernet plug ins and so on). 321 can be used on a flagpole or comprise a drop basket or drop box window pop-out. The drop box 321 can also include lid control 325 (if lid is used), and can be unlocked and/or auto-opened by a user's or delivery personnel phone, by any drone, or by user's computer located within the premises or anywhere remotely. Thus, a user can enter a code manually (keypad not shown in drop box 321 in FIG. 3), any device can open it from a remote and/or local position. Verification of delivery is conducted be means of cameras, weight change detectors (e.g. strain gauge) and by delivery personnel photo confirmation aided by drone image snap and confirmation.

In addition to opening the drop box 321, such as by providing a daily use public key that becomes invalid upon verifying a delivery, and managing remote/local opening control, 327 as a control unit can also manage communication inquiries (delivery schedule info, delivery received info, confirmation data examination, time of delivery and pickup and by whom—photo/vid of pick upper, and violence or theft detect triggered data capture (vid/audio)).

The platform 323 also provides a drone dock (not shown). It acts like a dock for airborne drones and, depending on nearness to the ground, could be for ground based drones in some configurations, and even for aquadrones in other configurations (for example, small boats that carry goods out to an island to drop off then return—a mini-taxi drone). Also, beacon unit 327 can have an associated sound or light beacon that is triggered by a delivery unit (even optics outside of visible range) for guidance over the last 10 meters. Beacon unit 327 can also be split into parts and for example have elements that are located in perspective orientations for 2D and 3D targeting—the final 10 meters verification and alignment after approach to make sure a perfect drop off is achieved into the right location/drop box (with proper alignment and positioning if necessary). The platform 323 also provides charging capabilities and acts like a charging station for drones 311 that need to be charged.

The present invention address last mile drone 311 delivery as it is an efficient and cost-effective approach to drone based delivery in most cities. For example, delivery bike drones are used to deliver items (such as food and groceries) and at the last few hundred meters before the destination, a drone is used for the final delivery, especially for apartments located not at ground level but at a higher level/storey. In addition, drones that are 3 wheelers with driving capabilities are also used to bring items to be delivered. These mobile street drones go on the street and when very close to a destination, a smaller mini drone is dropped down and it rolls up toward a door for possible interaction with users and dropoff. Similar techniques are used for all drone deliveries in some related configurations with street drones or trucks bringing the items close to a delivery point and subsequent delivery (say last few yards) conducted by smaller mobile drones with wheels that approach a premises or by airborne drones for delivery within the last few yards (for example from around the block or from the kerbside). Thus a truck or car (self driven or otherwise) gets in close to a premises or a neighbourhood and then drones (mobile air drones or drones with wheels) are disbursed to finish the delivery. Thus a delivery personnel can get to a neighborhood, attach stuff to all kinds of drones and send them and retrieve them (pickup), in cycles until all items to be delivered have been delivered (or delivery attempted), then locate those drones inside the truck and drive to next staging point for further delivery and pickup.

Drone 315 is a drone configuration for heavy payloads with retractable fixed tether (like an umbrella or old telescopic antenna). It could also be for service pickup of a defective drone 317 and could then use a rope tether too. Drone-2-Drone communication is enabled for such drones that are connected or tethered together or those that cooperate to deliver a heavy load—such communications are for example necessary for finding and linking up disabled drones or drones assigned for cooperative deliveries. In addition, for a disabled drone 317, Drone-2-Sender and Drone-2-central control communication is enabled via drone 315.

Beacon 351 provides similar features and functionality as those of beacon 327, but without the box lid opener capabilities of 327. Also, similar to beacon unit 327, beacon 351 can have an associated sound or light beacon that is triggered by a delivery unit (even optics outside of visible range) for guidance over the last 10 meters. Beacon unit 351 can also be split into parts and for example have elements that are located in perspective orientations for 2D and 3D targeting—the final 10 meters verification and alignment capabilities to make sure a perfect drop off is achieved into the right location/drop box.

Similarly, platform 333 is optionally provided with 327 functionality (without the lid opener capabilities) built in too, such as the product verification, dropoff alignment and positioning capabilities, and it can also guide delivery to a drop spot that is inside the balcony 331.

It is important to also note that beacons 351 and docking pad/platforms 333/323 get power via dc converter plugged into premises AC or via solar collectors. The 333 docking pad/platform can use resonant power transfer or can use positive and negative quadrants that a centered drone will end up making contact with by landing thereon with their feet conductive pads. The 333/323 platforms also deliver radiant heating or cooling directly to the payloads (like a pit stop to gain some pizza heat before making the final 100 m to the customer). The docking pad/platforms 323/333 and drop boxes 321 can be gifted items from common sender (such as AMAZON or FEDEX) and can be used for all deliveries from that sender alone if configured to be reserved for use by that particular sender (delivery means). They may also be used publicly to receive products sent by various senders too if configured for such behavior. For example if AMZN pays home owner for their docking use to service others (items sent to all neighbors, etc.). Camera/audio pickup/other sensors are also be placed for verification of delivery and pickup, for service and theft spotting, accompanied with voice warnings as necessary, and can monitor flyaways before someone can come in range. All theft spotting and voice warning (using Amazon Alexa for example) can come with the delivery box 321 too as a default configuration.

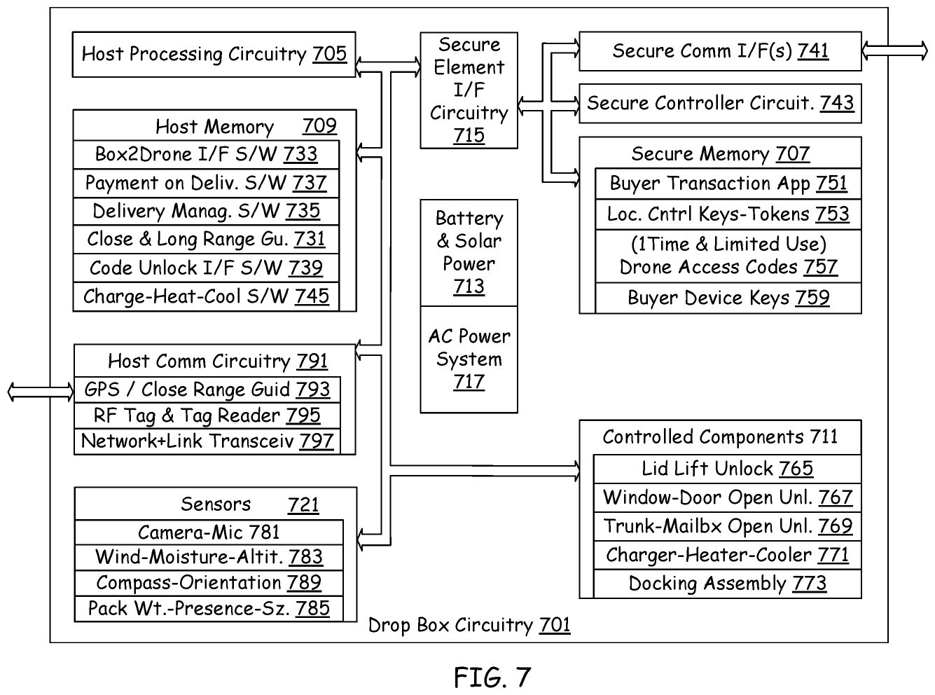

In one configuration the drop box 321 that comes with a closeable and lockable lid 325 is a secure drop box 321 located at a delivery site that supports a delivery of an item by drone 311 and pickup of items by drone 311 and other drones too. The secure drop box 321 comprises a container portion 329 configured to receive the item, and an access assembly, the access assembly being associated with the container portion controls access to the container portion. For example, in one example implementation the access assembly takes the form of the lid control 325 which can be securely unlocked and/or auto-opened by a user's or delivery personnel phone 361 (for example using access codes, one-time use passwords, etc. as appropriate), by any drone 311, or by user's computer located within the premises or anywhere remotely. The secure drop box 321 also comprises a drop box circuitry (described in detail below for FIG. 7) comprising a processing circuitry (not shown). The processing circuitry, only after confirming delivery authorization, directs the access assembly to provide access to the container portion 329 to receive the item, and, after receiving the delivery item, the processing circuitry directs the access assembly to secure the delivery item in the container portion 329. The processing circuitry, only after confirming receiver authorization, directs the access assembly to provide access to the container portion 329 to remove the item.

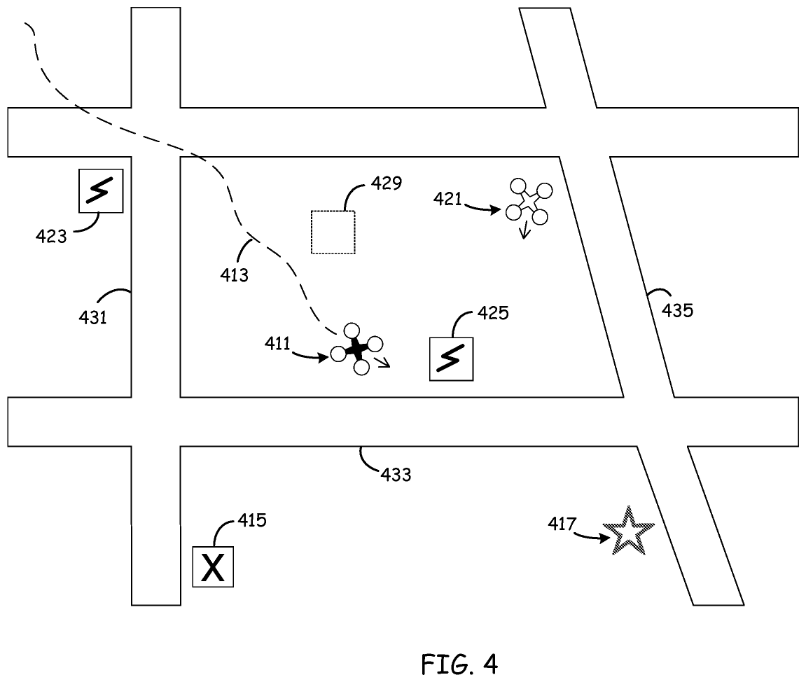

FIG. 4 is a block diagram of an exemplary head up display for sender, receiver and central management in a drone based delivery process using drop boxes with beacons that serve as delivery destinations. A delivery drone 411 is given a path 413 for a delivery to be made to a destination 417 and it receives beacon signals from drop boxes that are also charging stations 423, 425 along the path 413, as well as from the destination drop box 417 and the other drop box 415 in communicative proximity. Drone 411 also communicates with drone 421 (which is a drone to avoid but one that can communicate with a remote control system if necessary) to get flight path status information if necessary, and visual data of destination drop box 417 or of alternate drop boxes if necessary.

The drone 411 also makes use of visual cues along the path, such as roads 431, 433, 435 in visual proximity and of cross roads and intersections along the way. For example, such visual cues enable it to confirm it is continuing on the current path and that it has not deviated substantially from that path.

In one configuration, the exemplary head up display for sender, receiver and central management makes it possible to visually see what is being delivered, the traffic conditions along a path, the beacons that are working or not working, etc. It shows full city map, for example, with all registered drone activity. A user can see a subset that is related to their deliveries (which can include long distance icons on country or worldwide package delivery things such as UPS stuff). Then they can also see a truck delivery too on the map. But specifically for drones, as shown, they can see the current position in/along the delivery pathway. For example, the customer's package is being carried on drone 411 (black) with a pathway tracing shown 413.

By clicking on the drone 411 on the head up display, sender details, altitude, speed and other motion data, package content, package data (weight, current temperature, dry/wet, audible broken piece sounds), delivery and schedule info (ETA) etc. is revealed. Drop box/spots identified by blocks 415. Blocks with lightning bolt 423, 425 indicate a charging dock is available (such as on a drop box). Non-dashed box 415 implies that drop box had been in recent communication and so are likely present. Block with an “X” indicates full box so that further deliveries to it may be routed to other drop boxes in vicinity or a return will be initiated. Star indicates destination drop for the black drone 411. White drone 421 indicates drone to avoid but one that drone 411 (and the central management) can communicate with. Double clicking a box reveals content info, pickup info, drop info, fullness/emptiness, and so on. Dashed box 429 indicates out of communication (detached and maybe no longer in service). Central management (not shown in this fig) can access all of this info in databases or central management humans can use this interface for visual inspection of all drones for example in a city.

Any human operator using this head up display interface (sender, receiver or central manager) or AI based application can also use this data to reroute things, auto-contact sender (with concerns or delivery, theft, drone status, authorization/revocation and tracking info), auto-contact recipient (to warn of an incoming or sitting around delivery that isn't being picked up, theft, etc., much as above). A Sender (an individual or company sending a delivery), and Receiver (an individual or company expecting a delivery) can also arrange directly or via the central management a temporary delay (temp dock) or rerouting should weather get bad (rain) or receiver wants a neighbor pickup arrangement.

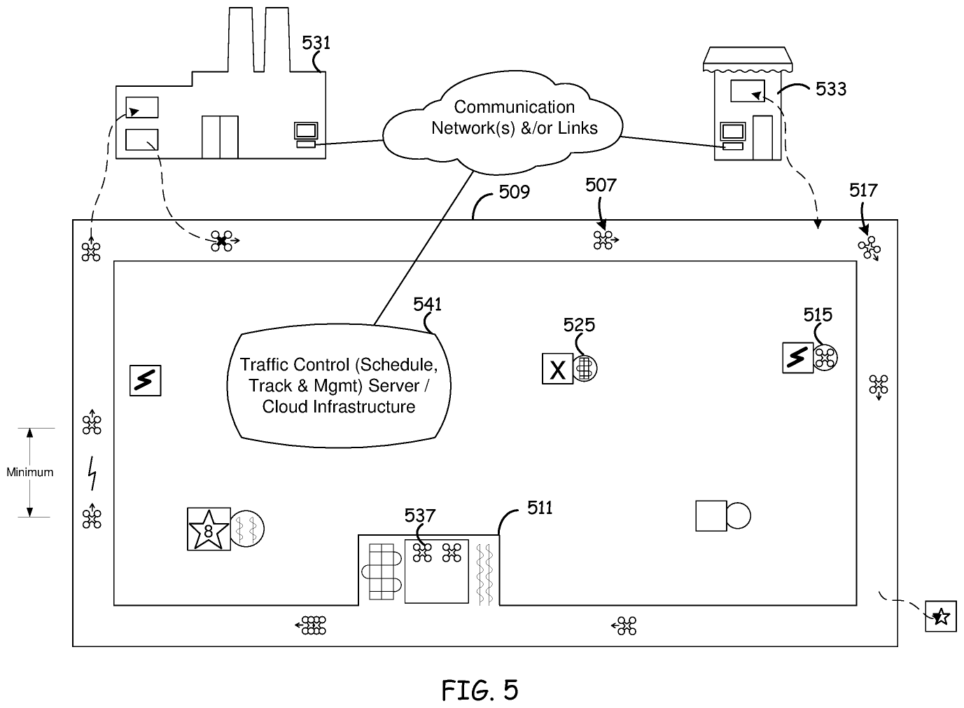

FIG. 5 is a diagram of a registered runway 509 (such as a drone superhighway) for drones that run in one direction per a given altitude thereby forming a thin square pipeway for a to- and fro-movement along a delivery path to a given destination. For example, a vendor such as Amazon 531 that delivers purchased products to buyers (living in buyer's premises 533) might purchase a to- and fro-path 509 that forms a virtual pipe riding across a city skyline at a fixed altitude range and fixed width in a cycle/loop/path. Drones 507, 517 from that vendor such as Amazon 531 just get on and off from that assigned loop/path 509 when needed to make close range drops. Minimum separation distances and drone2drone communication are specified and maintained, and flight traffic rules are made to adapt depending on the traffic levels and these can be controlled by a sender (if they own the pipe), and/or by the central management system. The pipe 509 (sometimes referred to as droneway) also comprises large, multi-drone docking sites 511 (secured) for airborne and ground/aqua drones to charge, heat, cool. The paths have designated charging stations for drones too. And some locations along the path are staging zones of special products that might require some preparation or special handling prior to delivery, or those that have been frequently provided to users and are therefore staged locally in anticipation of a delivery, where for example cold soft drinks might be picked up and dropped off at short distances versus carrying from a sender (e.g. pizza shop or factory).

In some configurations, drone pipes 509 are for ground/aqua too. Pipes/paths 509 can be bidirectional but likely preferable by drone systems if they are in one-directional loops. Their purpose is to keep heavy drone traffic out of neighborhood or other sensitive areas. By confining the paths to loops, for example loops above power lines, more efficient dedicated drone traffic lanes are established. Drone lanes can be bidirectional in some portions of the loop and not in others in some configurations, based on local traffic conditions, volume of packages for delivery originating from some stores/manufacturing plants, population densities in some regions along the path 509, etc.

Docking places/drop boxes 515, 525 here illustrated here in circles and docking/staging platform 511 shown attached to a pipe can be elevated based on drone type and products stored, and these docking stations 511 are housed to keep out rain. A drone 507 will fly in one side and fly out the other side of a in-path docking and staging center 511, and they can also be docked inside—sitting inside waiting for something—recharge, repair, battery replacement, weather to get break, etc.)

Central management 541 can also ground drones for any number of reasons and deliver instructions where to park. E.g., it may instruct a drone 537 to perma-dock at staging area 511 and await police pickup or a security check (if suspected of drugs or bomb or bioterror). And if drone does not respond, it can be intercepted or shot down from central station installed guns (for example employing an EM Pulse gun/device). Central management service for a drone 507 operated from a remote location/server makes sure that a drone is sealed, tamper proof/not opened, and is able to respond to all commands including downing and redirects, self identification, delivery data handover upon request, full system data query, test initiation, and so on to get ongoing or scheduled certification. Uncertified drones spotted are downed by command or by are shot down or alternatively removed by grappling by other drones. All certified drones that visually or otherwise detect a local drone must probe it in one configuration. If no response is received, it is reported along with sensor data. Central management 541 may take over delivery operations to get more info on a rogue drone. Drones located outside of allowed pipeways 509 are also reported by certified drones 507 along the pathways 509.

A public pipe/path might operate 24/7 at certain altitude and loop map. A vendors such as Amazon may operate 20 meters higher up in same loop map from 9 AM-6 PM in a dedicated fashion. Afterward, AMZN' s loop may be taken over by or shared with other delivery services such as UPS or used by general public. Pipeways 509 may also be assigned different loop locations in a city. But when close to or in proximity to a destination, drones 507 may drop out of the loop for the final meters to the delivery/pickup sites 533.

In one configuration, central management 541 comprises traffic control server that conducts scheduling of deliveries, traffic management, tracking of deliveries, etc. In another related configuration, central management 541 is service hosted in a cloud infrastructure.

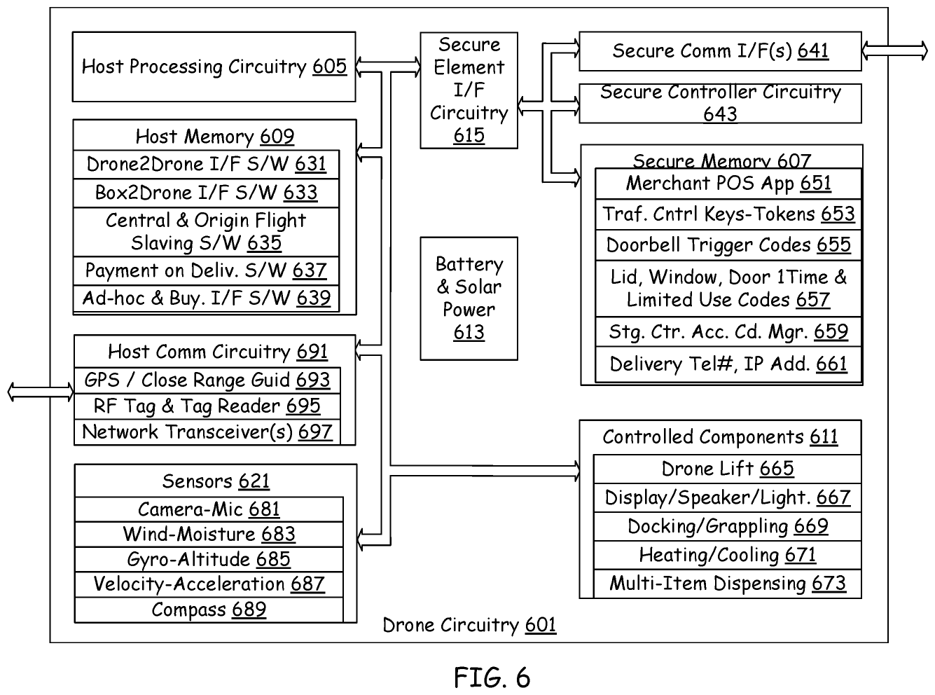

FIG. 6 is a block diagram of an exemplary drone circuitry 601 built in accordance with the present invention, that comprises a host processing circuitry 605 communicatively coupled to a secure memory 607 and a host memory 609, wherein the drone circuitry 601 also comprises controlled components module 611, sensors 621, a battery and solar power unit 613 and a secure element interface circuitry 615. The host processing circuitry 605 controls the various sensors 621 and based on their data manages the delivery operations, flight path tracking and monitoring, delivery verification and positioning, delivery scheduling and delivery coordination, as well as self-diagnosis and repairs. Communications with drop boxes, other drones nearby, and with central management servers and traffic management servers, etc. are facilitated by a host communication circuitry 691 that comprises a GPS/close range guide 693, an RF Tag & Tag Reader 695 and a network transceiver(s) 697.

The host memory 609 comprises a drone2drone interface software 631 that assists in communication with a one or more other drones in relative proximity, a box2drone interface software 633 that assists in communicating information and data to and from a drop box, a central&origin flight slaving software 635 that receives path information and traffic information, payment on delivery software 637 that assists local payment upon delivery and other adhoc purchases, and an adhoc & buyer interface 639 that interacts with buyers interested in opportunistic and adhoc purchases.

A secure communication interface 641 facilitates local communications with drop boxes, with devices used by adhoc purchasers, and it also facilitates drone-to-drone communications and command center to drone communications. A secure controller circuitry 643 facilitates receiving inputs from user interface(s), voice commands from users, remote commands from other drones, etc.

The secure memory 607 comprises several applications, apps, and monitoring software. For example it comprises a merchant POS app 651, a traffic control Keys-Token manager 653, a doorbell trigger codes manager 655, a dropbox lid, window, door manipulating 1Time & Limited use codes manager 657, a staging center access codes manager 659 and a delivery terminal number and IP Address manager 661.

The Controlled Components module 611 comprises several mechanical units and their corresponding manager applications/modules. For example, it comprises a drone lift unit 665, a display/speaker/lighting unit 667, a docking/grappling unit 669, a heating/cooling unit/unit 671 and a multi-item dispensing unit 673. Note that these units have their own drivers or managers in some configurations and the controlled components module 611 manages all these units to provide various delivery, repair, maintenance and security services.

The drone circuitry 601 employs the secure element interface circuitry 615 to interact with, and employ for secure communications and transactions, a secure element embedded in the drone circuitry 601 or with a secure element provided in an externally inserted programmed card such as a credit card, a mobile device secure identification module, etc.

The drone circuitry 601 employs the battery & solar power unit 613 to power its flight, power its interactions with external servers and drones, power its transactions, monitoring of traffic, interactions with drop boxes, etc. It also monitors the recharging needs and finds charging stations as necessary and facilitates docking for recharging.

The drone circuitry 601 also comprises and makes use of several sensors 621 such as the camera and microphone 681, a wind and moisture sensor 683, a gyro-altitude sensor 685, a velocity and acceleration sensor 687 and a compass 689.

FIG. 7 is a block diagram of an exemplary drop box circuitry 701 built in accordance with the present invention, that comprises a host processing circuitry 705 communicatively coupled to a secure memory 707 and a host memory 709, wherein the drone circuitry 701 also comprises controlled components module 711, sensors 721, a battery and solar power unit 713 and a secure element interface circuitry 715. The host processing circuitry 705 controls the various sensors 721 and based on their data manages the delivery operations, flight path tracking and monitoring, delivery verification and positioning, delivery scheduling and delivery coordination, as well as self-diagnosis and repairs. Communications with drones, other drop boxes nearby, premises digital equipment such as doorbells, phones, etc., and optionally with central management servers and traffic management servers, are facilitated by a host communication circuitry 791 that comprises a GPS/close range guide 793, an RF Tag & Tag Reader 795 and a network & link transceiver(s) 797. An AC power system 717 is provided that not only facilitates regular operation of the drop box circuitry 701 but also facilitates charging of docked drones, charging of other equipment such as mobile devices, as necessary.

The host memory 709 comprises a dropbox2 dropbox interface software that assists in communication with a one or more other drop boxes in relative proximity, a box2drone interface software 733 that assists in communicating information and data to and from a drop box, payment on delivery software 737 that assists local payment upon delivery and other adhoc purchases, a close and long range guidance software 731 that helps guide a drone to approach the drop box in the right manner and with the right orientation, a delivery management software 735 that tracks delivery, monitors the success or failure of delivery attempts, reports success or failure information, collects data, etc. The host memory 709 also comprises a code unlock interface software 739 that facilitates secure retrieval of delivered items by authorized buyers and other authorized individuals, and a charge-heat-cool software 745 that manages heating of delivered products such as pizzas if necessary, cooling of delivered products such as beer, frozen food or chocolates if necessary, and charging of delivered products or drones themselves if such charging is required. The charge-heat-cool software 745 factors in product types, ambient temperatures, moisture in atmosphere, and several other factors including product shape and size.

A secure communication interface 741 of the drop box circuitry 701 facilitates local communications with drones, with in-premises equipment and appliances etc. It also facilitates drop box-to-drone communications and command center to drone communications via the drop box circuitry 701 (for example for drones that are out of touch or incapable of communicating with the command center). A secure controller circuitry 743 facilitates receiving inputs from user interface(s), voice commands from users, remote commands from other drones, etc.

The secure memory 707 comprises several applications, apps, and monitoring software. For example it comprises a buyer transaction app 751, a location control Keys-Token manager 753, a dropbox lid, window, door manipulating 1Time & Limited use drone access codes manager 757, and a buyer device keys manager 759.

The Controlled Components module 711 comprises several mechanical units and their corresponding manager applications/modules. For example, it comprises a lid lift unlock unit 765, a window-door opener unlock unit 767, a trunk-mailbox open unlock unit 769, a charger-heater-cooler unit 771 and a docking assembly 773. Note that these units have their own drivers or managers in some configurations and the controlled components module 711 manages all these units to provide various delivery, repair, maintenance and security services.

The drop box circuitry 701 employs the secure element interface circuitry 615 to interact with, and employ for secure communications and transactions, a secure element embedded in the drone circuitry 601 or with a secure element provided in an externally inserted programmed card such as a credit card, a mobile device secure identification module, etc.

The drop box circuitry 701 employs the battery & solar power unit 713 to power its operations (including heat, cooling, opening, closing), power its interactions with external servers and drones, power its transactions, monitor traffic, monitor if its full, interactions with other drop boxes, etc. It also monitors the recharging needs of drones as necessary and facilitates docking of drones for recharging. The AC power system 717 facilitates operating heating elements, cooling elements, actuators to open or close lids or doors, operating sliding platforms, charge docked drones etc. as necessary.

The drone circuitry 701 also comprises and makes use of several sensors 721 such as the camera and microphone 781, a wind and moisture altitude sensor 783, a pack weight, presence and size sensor 785, a compass & orientation sensor 789.

The GPS/close range guide 793 facilitates approach, delivery drop and optional docking by drones. The RF Tag & Tag Reader 795 facilitates verification of drones, verification of delivery by authorized drones, reporting of items delivered, reporting of wrong items delivered by mistake, etc. The network and link transceiver(s) 797 helps receive instructions for deliveries, schedules for deliveries, codes for accepting deliveries, codes for allowing retrieval by specific authorized users, communicating notifications, communicating alert messages (such as drop box full, drop box inoperative, etc.), and coordination of delivery across several drop boxes in proximity.

In one embodiment, a secure drop box located at a delivery site, such as the drop box 321 of FIG. 3 that comes with an access assembly 325 in the form of a closeable and lockable lid, supports a delivery of an item and pickup of items. The secure drop box 321 comprises a container portion 329 configured to receive the item, and an access assembly 325, the access assembly 325 being associated with the container portion 329 controls access to the container portion 329. The secure drop box 321 also comprises the drop box circuitry 701 comprising the host processing circuitry 705. The host processing circuitry 705, only after confirming delivery authorization, directs the access assembly (for example, the hinged lid 325 of the drop box 321 of FIG. 3, or a sliding lid of a window based drop box 215 of FIG. 2, etc.) to provide access to the container portion 329 to receive the item, and, after receiving the delivery item, the host processing circuitry 705 directs the access assembly 325 to secure the delivery item in the container portion 329. The processing circuitry 705, only after confirming receiver authorization, directs the access assembly 325 to provide access to the container portion 329 to remove the item.

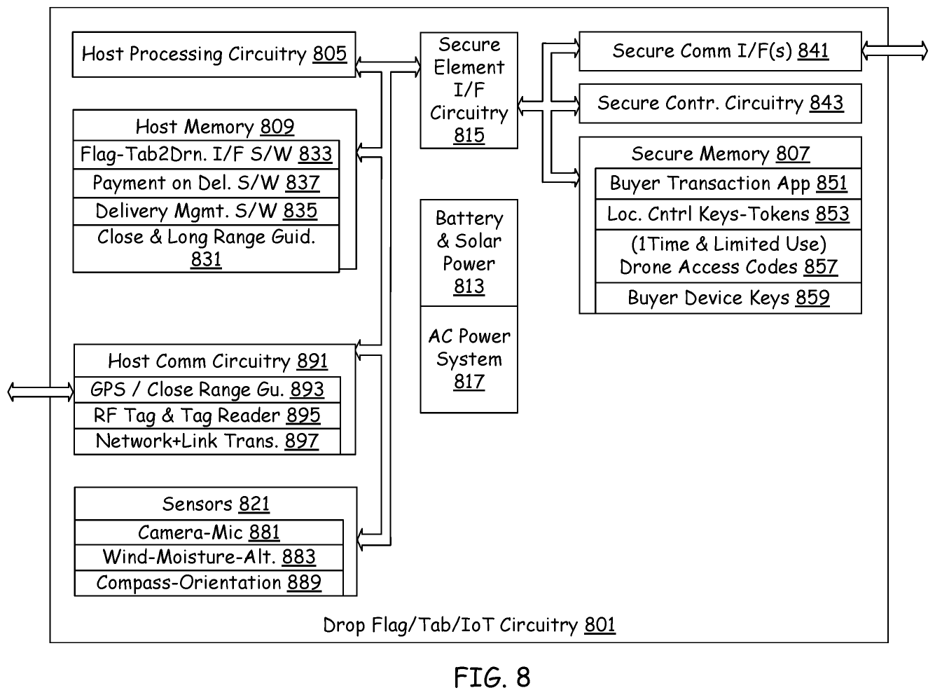

FIG. 8 is a block diagram of an exemplary drop Flag/Tab/IoT circuitry 801 built in accordance with the present invention, that guides drone during delivery, interacts with drones as necessary, enforces access security if necessary, monitors traffic and reports problems. The drop Flag/Tab/IoT circuitry 801 comprises a host processing circuitry 805 communicatively coupled to a secure memory 807 and a host memory 809, wherein the drop Flag/Tab/IoT circuitry 801 also comprises sensors 821, a battery and solar power unit 813 and a secure element interface circuitry 815. The host processing circuitry 805 controls the various sensors 821 and based on their data manages the delivery operations, flight path tracking and monitoring, delivery verification and positioning, delivery scheduling and delivery coordination, as well as self-diagnosis and repairs. Communications with drones, other drop boxes nearby, premises digital equipment such as doorbells, phones, etc., and optionally with central management servers and traffic management servers, are facilitated by a host communication circuitry 891 that comprises a GPS/close range guide 893, an RF Tag & Tag Reader 895 and a network & link transceiver(s) 897. An AC power system 817 is provided that not only facilitates regular operation of the drop Flag/Tab/IoT circuitry 801 but also facilitates charging of docked drones, charging of other equipment such as mobile devices, as necessary.

The host memory 809 comprises a flag-tab2drone interface software 833 that assists in communication with one or more other drones in relative proximity and communication also assists if necessary in communicating information and data to and from a drop box in proximity. The host memory 809 also comprises a payment on delivery software 837 that assists local payment upon delivery and other adhoc purchases, a delivery management software 835 that tracks delivery approaches, deliveries, monitors the success or failure of delivery attempts, reports success or failure information, collects data, etc., and a close and long range guidance software 831 that helps guide a drone to approach a nearby drop box in the right manner and with the right orientation. Thea flag-tab2drone interface software 833 also cooperates with other drop boxes to take video and/or photos of the pick up or drop off event.

The drop flag/tab/IoT circuitry 801 act as digital beacons, as well as visual location indicators, to drone based as well as mobile human-based delivery operations, and they enable delivery to a location close to or in proximity to where they are currently placed/located. For example a drone can visually locate a drop off location by see a drop flag on a patio or balcony. It can also confirm its delivery location by digitally communicating with the drop flag/tab/IoT circuitry 801 when in communicative proximity.

The host memory 809 also comprises a delivery management software 835 tracks delivery, monitors the success or failure of delivery attempts, reports success or failure information, collects data, etc.

A secure communication interface 841 of the drop flag/tab/IoT circuitry 801 facilitates local communications with drones, with in-premises equipment and with appliances etc. It also facilitates close and long range guidance of drones. A secure controller circuitry 843 facilitates receiving inputs from user interface(s), voice commands from users, remote commands from other drones, etc.

The secure memory 807 comprises several applications, apps, and monitoring software. For example it comprises a buyer transaction app 851, a location control Keys-Token manager 853, a 1Time & Limited use drone access codes manager 857, and a buyer device keys manager 859.

The drop flag/tab/IoT circuitry 801 employs the secure element interface circuitry 815 to interact with, and employ for secure communications and transactions, a secure element embedded in the drone circuitry 601 or with a secure element provided in an externally inserted programmed card such as a credit card, a mobile device secure identification module, etc.

The drop flag/tab/IoT circuitry 801 employs the battery & solar power unit 813 to power its operations, power its interactions with external servers and drones, power its transactions, monitor traffic, monitor if its full, interactions with other drop boxes, etc. It also monitors the recharging needs of drones as necessary and facilitates docking of drones for recharging. The AC power system 817 facilitates charging docked drones etc. as necessary.

The drop flag/tab/IoT circuitry 801 also comprises and makes use of several sensors 821 such as the camera and microphone 881, a wind and moisture altitude sensor 883, and a compass & orientation sensor 889.

The GPS/close range guide 893 facilitates approach, delivery drop in proximity to drop flags and drop tabs, and optional docking by drones. The RF Tag & Tag Reader 795 facilitates verification of drones, verification of delivery by authorized drones, reporting of items brought for delivery, reporting of wrong items brought for delivery by mistake, etc. The network and link transceiver(s) 897 helps receive instructions for deliveries, schedules for deliveries, codes for accepting deliveries, communicating notifications, communicating alert messages (such as drop box full, drop box inoperative, etc.), and coordination of delivery across several drop boxes in proximity.

In one embodiment, the drop flag/tab/IoT circuitry 801 is incorporated into a gate of a house and enables coordination of delivery by drones. In another embodiment, the drop flag/tab/IoT circuitry 801 is incorporated into a residential mailbox outside a residence. In yet a different embodiment, it is incorporated into a table/lawn furniture located in a lawn of a residence. Incorporation into other forms of appliances and furnitures are also contemplated.

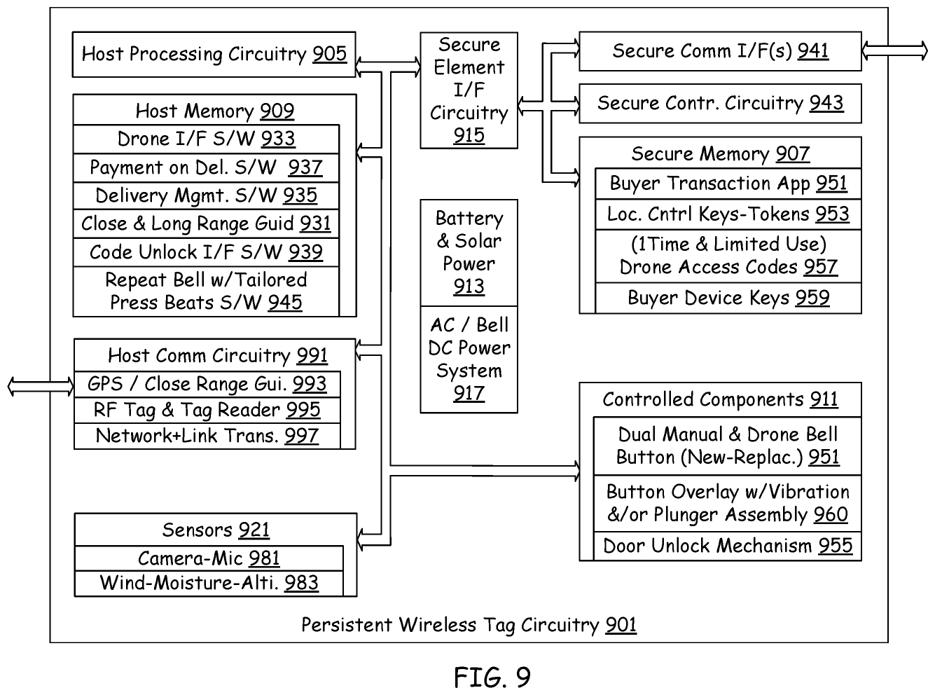

FIG. 9 is a block diagram of an exemplary persistent wireless tag circuitry 901 built in accordance with the present invention, that comprises a host processing circuitry 905 communicatively coupled to a secure memory 907 and a host memory 909, wherein the persistent wireless tag circuitry 901 also comprises controlled components module 911, sensors 921, a battery and solar power unit 913 and a secure element interface circuitry 915. The host processing circuitry 905 controls the various sensors 921 and based on their data manages the delivery operations, flight path tracking and monitoring, delivery verification and positioning, delivery scheduling and delivery coordination, as well as self-diagnosis and repairs. Communications with drones, other drop boxes nearby, premises digital equipment such as doorbells, phones, etc., and optionally with central management servers and traffic management servers, are facilitated by a host communication circuitry 991 that comprises a GPS/close range guide 993, an RF Tag & Tag Reader 995 and a network & link transceiver(s) 997. An AC power system 917 is provided that not only facilitates regular operation of the persistent wireless tog circuitry 901 but also facilitates charging of docked drones, charging of other equipment such as mobile devices, as necessary.

In one configuration, the persistent wireless tag circuitry 901 is configured to monitor and record motion events, drop box door/window open/close events, and to collects data on temperature/humidity/soil moisture and water leaks. It is configured to send buyers and central management servers notifications on deliveries, alerts on delivery conditions, (such as rain, intense heat, etc.) emails, text messages, etc. The persistent wireless tag circuitry 901 notifies a buyer (or delivery candidate) on a corresponding mobile phone when temperature or humidity is too low or too high for delivery of specific items anticipated. It also alerts a user if the item that it is tagged on (attached to)—the tagged item, has been moved even only slightly, or when the tag has been covered up, etc. It is possible to view reports and alerts sent by the persistent wireless tag circuitry 901 on mobile devices and on the Internet via a browser. The persistent wireless tag circuitry 901 can be attached to drop boxes, to balcony ledges, to patio furniture, and to items in your house where delivery should occur. They can be located by beeping each tag from any browser or your mobile phone.

The persistent wireless tag circuitry 901 also communicates alerts and messages as needed based on events received from sensors 921, delivery schedules and geofences determined.

The host memory 909 comprises a drone interface software 933 that assists in communicating information and data to and from a drone, to and fro from a drop box nearby, etc. The host memory 909 also comprises payment on delivery software 937 that assists local payment upon delivery and other adhoc purchases, a close and long range guidance software 931 that helps guide a drone to approach the drop box in the right manner and with the right orientation, a delivery management software 935 that tracks delivery, monitors the success or failure of delivery attempts, reports success or failure information, collects data, etc. The host memory 909 also comprises a code unlock interface software 939 that facilitates secure retrieval of delivered items by authorized buyers and other authorized individuals, and a repeat bell with tailored press beats software 945 that manages generating audio alerts for products delivered such as pizzas if necessary, alerting a user by causing a doorbell to ring in a certain mode, employing tailored press beats (such as a different beat for each different delivery service, for each different products delivered, etc.) is required.

A secure communication interface 941 of the persistent wireless tag circuitry 901 facilitates local communications with drones, with in-premises equipment and appliances etc. It also facilitates dropbox-to-drone communications and command center to drone communications via the persistent wireless tag circuitry 901 (for example for drones that are out of touch or incapable of communicating with the command center). A secure controller circuitry 943 facilitates receiving inputs from user interface(s), from mobile devices in proximity, voice commands from users, remote commands from other drones, etc.

The Controlled Components module 911 comprises several mechanical and electronic assemblies. For example it comprises a dual manual & doorbell button (new-replacement) app 951 that facilitates doorbell ringing, user alerts using audio or voice alerts, etc., a button overlay w/vibration & or plunger assembly 953 that facilitates user interaction and event handling, a door unlock mechanism 955 that allows access to doors of premises, doors of drop boxes, etc. Note that these assemblies have their own drivers or managers in some configurations and the controlled components module 91 manages all these units to provide various alerts, delivery, monitoring and security services.

The secure memory 907 comprises several applications, apps, and monitoring software. For example it comprises a buyer transaction app 951, a location control Keys-Token manager 960, a 1Time & Limited use drone access codes manager 957 that monitors access by users/buyers and controls access based on access code provided by user, and a buyer device keys manager 959 that stores and manager several different security keys for several different authorized users/buyers.

The persistent wireless tag circuitry 901 employs the secure element interface circuitry 915 to interact with, and employ for secure communications and transactions, a secure element embedded in the persistent wireless tag circuitry 901 or with a secure element provided in an externally inserted programmed card such as a credit card, a mobile device secure identification module, etc.

The persistent wireless tag circuitry 901 employs the battery & solar power unit 913 to power its operations (including monitoring, tracking, alerting), power its interactions with external servers and drones, power its transactions, monitor traffic, monitor if its full, interactions with other drop boxes, etc. It also monitors the recharging needs of drones as necessary and facilitates docking of drones for recharging. The AC power system 917 facilitates various alerting, monitoring and tracking activities as necessary.

The persistent wireless tag circuitry 901 also comprises and makes use of several sensors 921 such as the camera and microphone 981, a wind and moisture altitude sensor 983.

The GPS/close range guide 993 facilitates approach, delivery drop and optional docking by drones. The RF Tag & Tag Reader 995 facilitates verification of drones, verification of delivery by authorized drones, reporting of items delivered, reporting of wrong items delivered by mistake, etc. The network and link transceiver(s) 997 helps receive instructions for deliveries, schedules for deliveries, codes for accepting deliveries, codes for allowing retrieval by specific authorized users, communicating notifications, communicating alert messages (such as drop box full, drop box inoperative, etc.), and coordination of delivery across several drop boxes in proximity.

In one configuration, the persistent wireless tag circuitry 901 helps convert an appliance, a gate, a furniture, or a balcony into a smart delivery drop box with security, notifications and monitoring functionality.

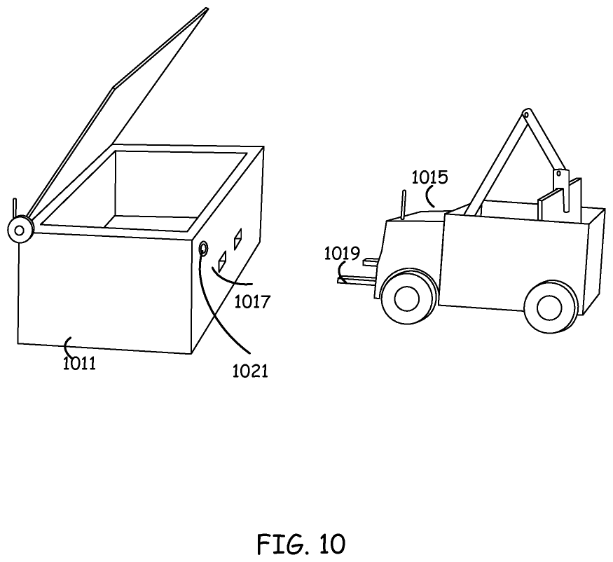

FIG. 10 is a perspective diagram of a delivery drone 1015 that docks with charging stations as necessary to recharge its batteries and complete its delivery mission. The battery & solar power unit (for example, the battery & solar power unit 613 of FIG. 6) of the drone circuitry is capable of docking with charge stations for charging purposes, and even with drop boxes 1011 with charging connections 1017. When docked, a control signal is delivered through dock ports 1019 (prongs) which also stabilize a lift. A docking station on a drop box's control unit may act in some configurations as described in reference to FIG. 3 but may operate with contact communication flow from the forks 1019 as well as for charging or heating/cooling. The charging forks 1019 also provide an optional communication flow back through the drop box to reach the sender, recipient or central control system (for example the drop box 1011 is connected to the recipient's home device such as Alexa echo and through that accesses the central drone control system 161 of FIG. 1). The camera element 1021 illustrated in FIG. 10 captures a delivery/drop event and also includes an illuminator/lighting unit (even UV or infrared as necessary) for signaling the ground drone 1015 (for guidance) and targeting for the forked dock 1017. Ground drone 1015 and placing mechanism can be designed to fit a particular payload type such as priority letter sized packages. In some configurations, the fork 1019 connectors are shaped like pizza box stacks and lifters such as those on garbage trucks.

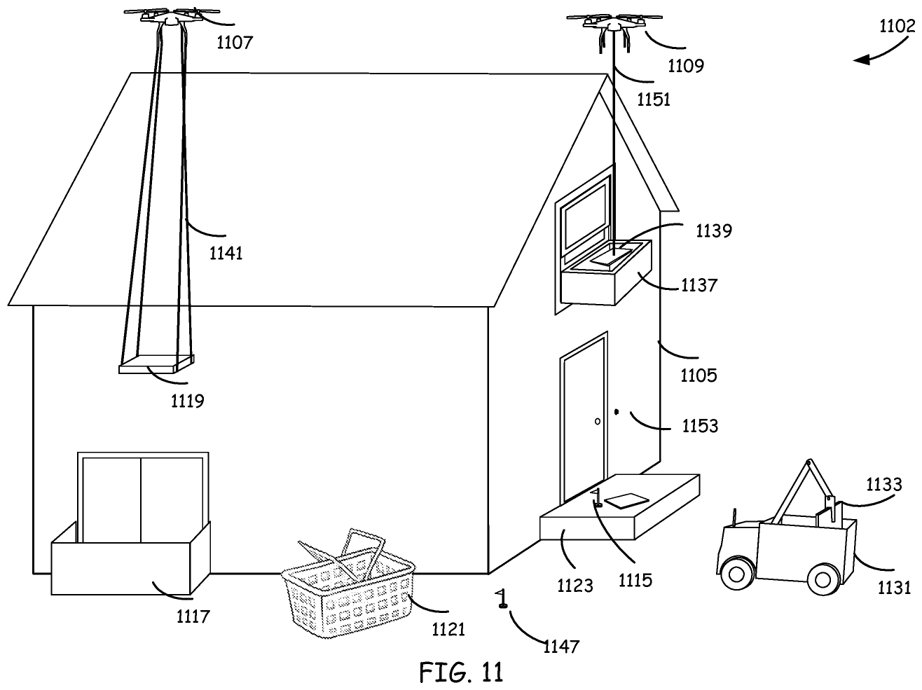

FIG. 11 is a perspective diagram of a drone system 1102 wherein the effects of drones 1107, 1109 getting too close to users or to equipment in user premises thereby endangering them is alleviated by the use of longer and retractable tethers 1141, 1151 to lower packages 1119 to their drop spots 1117, 1137 respectively. Thus airborne drones 1107, 1109 that may be dangerous in some environments, that may be noisy, subject to theft and damage can now be used safely for delivery as they no longer have to get too close to people, pets or to equipment in people's premises 1105. To minimize these dangers, airborne drones 1107, 1109 can now use longer and retractable tethers 1141, 1151 to lower packages to their drop spots. This also avoid head level drone issues and pet bait, as tethering down deliveries keeps drones at a distance from danger. In one configuration, these tethers have a release mechanism to drop the packages/items when close to ground or delivery location. In another configuration, the user/buyer is expected to “release” the tethered delivery items from their respective tethers.

In addition, drones 1107, 1109 are instructed to survey/look over a drop area 1137, 1115, 1117 before proceeding to deliver. For example, kids may be playing or pets and delivery on top of kids, or too close to kids, are likely to be dangerous. Similarly, a known thief might be spotted, or something may be blocking the access to/way to the receivers property. Flagging this helps reschedule delivery or in determining alternate drop destinations. Similarly, spotting an elderly person with a cane close to the drop spot makes the drone defer delivery, stand back and wait for an opportunity to deliver. Alternately, different drop box 1121 locations may be selected or suggested for delivery, or a recipient may be notified so they can change the environment. Voice instructions are also delivered to help clear the way or warn of incoming/ongoing delivery along with flashing yellow lights.

Sometimes a delivery drone may get close to a drop location 1123 and not know where the receiver (and or sender) wants the item to be dropped—this problem is also solved by the present invention. The use of doorbell 1153 to alert the user, the option to deliver using drone 1109 face to face to the user, indicating delivery spot using a front drop flag 1115, using a drop basket 1121, indicating a patio as a delivery spot 1123, indicating a windowed drop box 1137 as a destination, are all facilitated and supported by the present invention. All are deliveries can be arranged beforehand by a user. For example, if a user wants a pizza delivered to door only, when the user places an order, the user can also specify five locations to drop the delivery, i.e. have 5 locations registered as drop spots to his home. The user may choose dropdown delivery with doorbell drop. Next day, the same user may have a package that is rather big delivered. The sending entity (such as Amazon or an online merchant for example) calls the Sender if necessary, remotely (or using drone 1109) peruses the sizes of a user's 5 registered drop spots and decides (even employing AI apps or automated delivery rules) to choose doorbell and, failing such delivery, deliver on the patio. The delivery drone 1109, on getting to the premises 1105, discovers that the doorbell is unanswered (after attempting doorbell activation/alert), that the patio 1123 is already full and then the delivery drone 1109 changes the drop spot to offer a less secure flag drop 1147—then contacts the user over phone to let him know where the drop/delivery can occur given the present conditions. The user can reject the suggested drop spot 1147 and choose to reschedule, opting for a later 7 PM delivery time to doorbell 1153 (at the front door for example with doorbell rung). So the delivery drone 1109 rolls to a secure charging box and waits till 7 PM when it completes the delivery.

The user can setup his order of delivery spots 1153, 1115, 1137, 1117, 1147, his choice of drone types for delivery (noisy, silent ones, fast delivery, big box delivery, liquid delivery drones, etc.) his preferred delivery times, etc. The user can also elect to have all or some of the deliveries videotaped, and access provided to such videos.

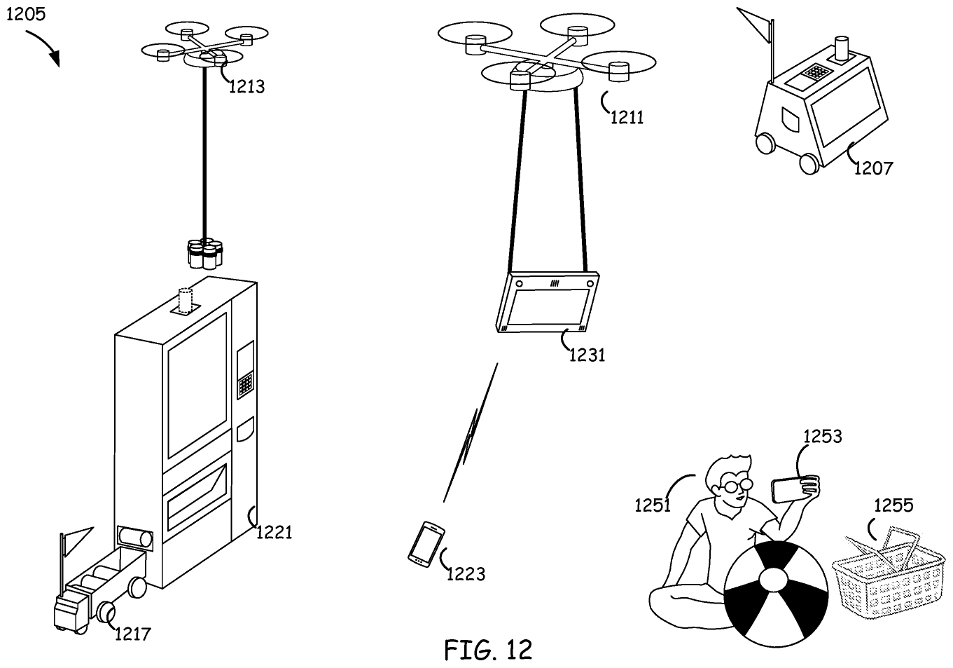

FIG. 12 is a perspective diagram of a drone based delivery system 1205 that involves not only delivery aided by aerial drones 1211 but also ground based mobile drones 1207, that facilitates not only delivery into staging areas 1221, people's residences but also into drop baskets 1255 and adhoc destinations specified by a user 1251 using his tablet 1253 (using a delivery app for example).

Opportunistic requests by users for items, such as the user 1251 with the mobile device 1253 outdoors requesting delivery of a pizza from a mobile drone 1207 moving close by, or requesting a beer from a drone 1213 flying in proximity with a six pack of cold beer, are received by the drones (mobile drone 1207 and the airborne drone 1213, respectively) and deliveries made along with conducting of billing transactions based on payment information provided by the user 1251 via the mobile device 1253.

When the user 1251 places an adhoc order for delivery of a product 1231 (such as a pizza for example), he uses an app on his tablet 1253 (or mobile device) and based on a determined location, and based on his preferred products ordered, and based on proximity to the user 1251, either an aerial drone 1211 is employed to deliver the ordered product 1231 or a ground based mobile drone 1207 is employed to deliver the product (such a cold drinks, snacks, etc.).

Drone 1213 is used to pick up cold drinks from a staging area 1221 to deliver quickly to a user 1251 who is nearby. Similarly, ground based mobile drone 1217 is employed to deliver drinks and other appropriate food items and other consumer items to the user 1251, based on convenience of delivery, and based on actual products and their characteristics and constraints, and based on other criteria as applicable.

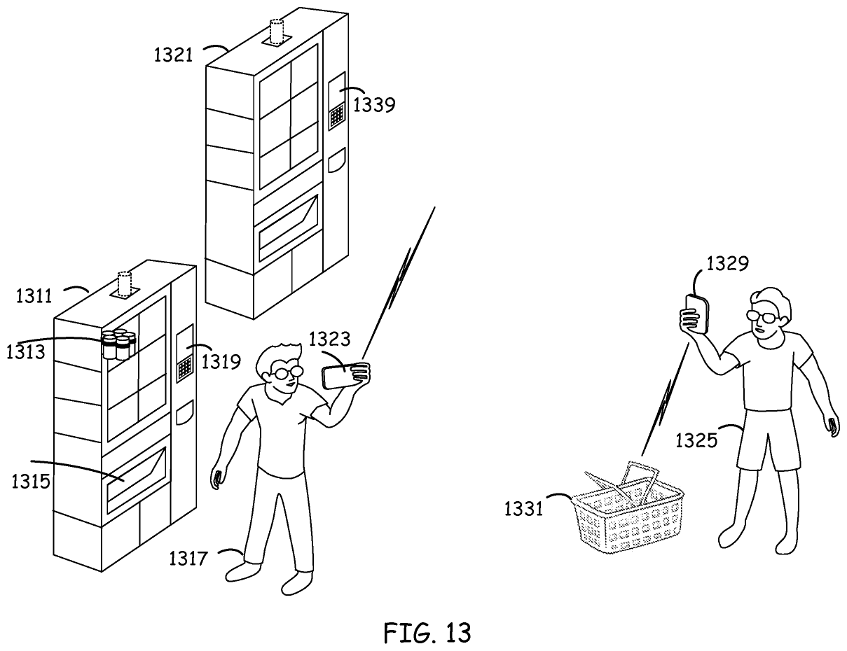

FIG. 13 is a perspective diagram of a communal drop box delivery and secure pickup configuration wherein secure multi delivery box modules 1311, 1321 each with a digital user interface 1319, 1339 make it possible to provide convenient centralized delivery solutions in each neighborhood. For example, a user 1317 who has just ordered an item online from Amazon or some such service gets a delivery alert to pickup his ordered items that have been delivered by a drone to a local store or business location comprising secure multi delivery box modules 1311 housed in the local store or business location (such as Albertson's grocery or COSTCO store), the delivery alert also providing a special security code to be used for retrieval of the item(s) from the designated one of the secure multi delivery box modules 1311. The user 1317 is prompted to provide the special security code wirelessly from his mobile device 1323 or enter the special code (and other required information such as a transaction tracking number, if necessary) employing the digital user interface 1319. Thus the user has to just walk up a small distance to his local store and provide the special security code to conveniently and securely retrieve the items purchased/ordered online.

In one embodiment, the secure multi delivery box modules 1311 each comprise a plurality of secure delivery boxes 1313, 1315 that can hold different items delivered by a drone, by a delivery man, by a delivery service, etc. Each secure delivery boxes 1313, 1315 is provided a unique identification and a special security code. The special security code is a common reusable security code in one configuration, and a reprogrammable security code that changes after each use in another configuration. Items delivered by a human walking up to the secure multi delivery box modules 1311 for pickup by a user 1317 can be delivered by drones, by other humans, by a third party delivery service, etc. Thus, drones that are used to drop items/make deliveries to several different houses in the neighborhood can also make deliveries to these secure multi delivery box modules 1311 for subsequent pickup by user 1317. The delivered items gets locked in the individual secure delivery boxes 1313, 1315 and the corresponding buyer (one who ordered the item for delivery) is sent a special security code that allows him/her to unlock the designated secure delivery box 1313 and access the delivered item(s). For example, the buyer 1317 gets the special security code on the buyer's mobile phone 1323, so that the buyer can walk or drive a short distance to pick up at a communal delivery pickup place such as a local store or business.

Similarly, a communal drop basket 1331 with a locking facility is provided wherein any person 1325 living in the neighborhood can use that communal drop basket 1331 as a place to pickup items delivered for him. For example, the identification and location of the communal drop basket 1331 are sent to the mobile device 1329 of the user 1325 in an alert to pickup the items he has ordered, the delivery of which has been made to the communal drop basket 1331. Upon presenting the special security code to the communal drop basket 1331 wirelessly from the mobile device 1329, via a digital user interface on the communal drop basket 1331, or via a mobile app provided on the mobile device 1329, the user 1325 is provided access to the items delivered for him.

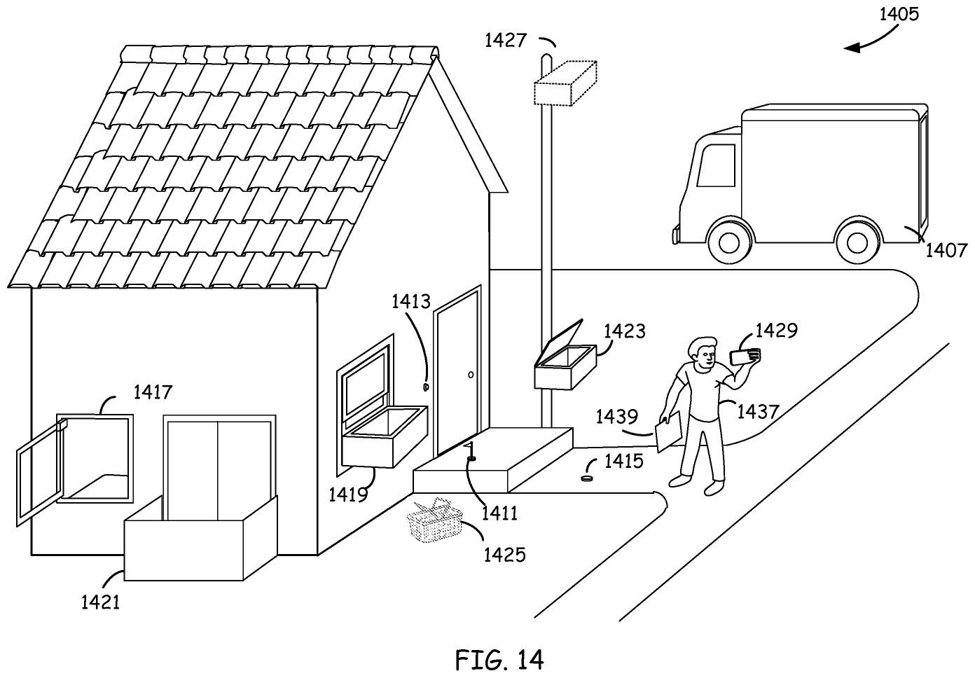

FIG. 14 is a perspective diagram of a premises 1405 that supports mobile drones (land drone) based deliveries, kerbside human deliveries into drop boxes 1423, 1419, and airborne drone based deliveries into drop boxes 1423, 1419, balconies 1421 and secure baskets 1425, etc. A postman or delivery personnel (human) 1437 who gets close to a premises 1405 is then guided in to make the final drop in accordance with this invention. All previous interactions described in previous figures are possible in this scenario described for FIG. 14 but one important aspect here is that the human being 1437 delivering a product 1439 is directed by the phone/tablet device 1429 in his hand that is carried along with a box/package 1439 to be delivered. Specifically, the human 1437 delivery personnel interacts with the delivery system via the delivery tablet 1429. For example, directions, access codes, instructions on placement and schedules, preferences of drop boxes and locations, alternate drop locations, and rescheduling abilities are provided via the delivery tablet 1429.

Similar to the human delivery personnel 1437 delivering a package 1439 with the help of a drone system that provides detailed instructions and codes to the human 1437 via the tablet 1429, a drone based delivery is also facilitated by the same drone system wherein drop boxes 1423 (that slides down a post if necessary for human based delivery), secure balcony 1421, sliding drop box 1419, secure window 1417 are specified as required (based on security needs, based on product size, based on anticipated weather, etc.) are also identified as drop off locations for products by drones.

Thus the drone based delivery system supports mobile land-based drone 1407 deliveries to a the curbside of a premises and subsequent human deliveries into a drop box 1423, flying air drone 143, 221 based deliveries into drop boxes 1423, 1419, 1425, etc.

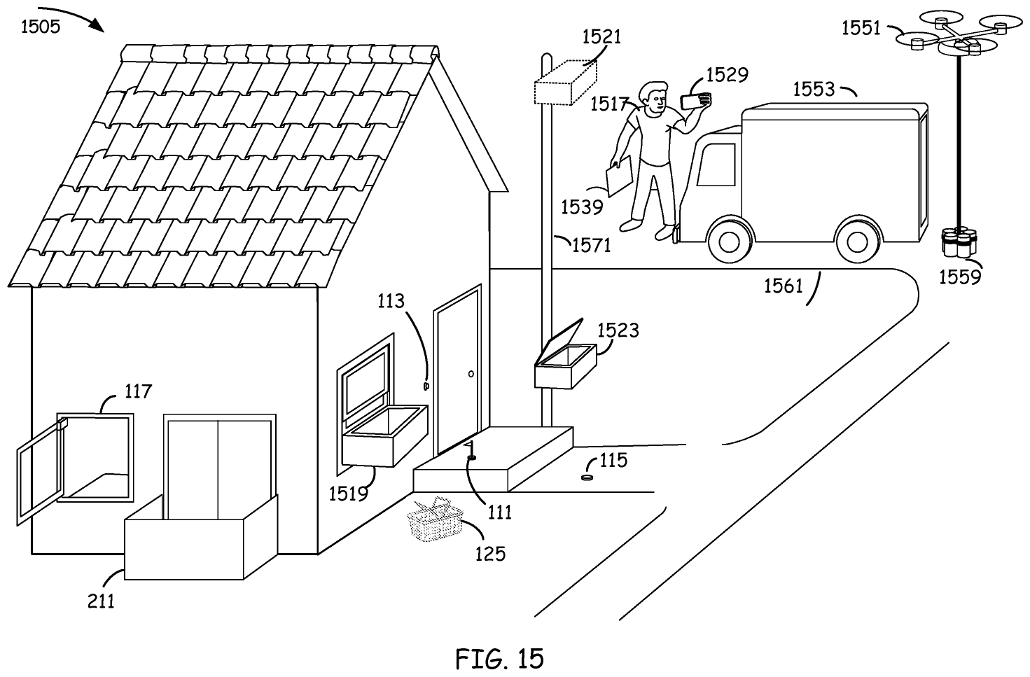

FIG. 15 is a perspective diagram of a premises 1505 that supports human deliveries of a package 1539 by a human delivery man 1517, a flying air drone 1551 based delivery of packages 1559 into drop boxes 1523, 1519 etc. as well as delivery by a mobile truck 1553 wherein a user in the premises is prompted to come to the kerbside 1561 to pick up a package brought by the mobile truck 1553. The human delivery man 1517 employs the mobile device 1529 to not only locate the drop box 1523 into which a delivery is to be made by the human delivery man 1517, but also employs the mobile device 1529 to enter an access code that results in the opening of the drop box 1523 to make it possible for the human delivery man 1517 to deposit the package 1539 into a container portion of the drop box 1523. The drop box 1523 in one configuration is hoisted to the top of the pole 1571 for safe keeping as well as for enabling delivery by drone 1551 even when the drop box 1523 is in an elevated position 1521. If the drop box 1523 is in the elevated position 1521, it is brought down for access by the human delivery man 1517 when instructed by the human delivery man 1517, such as by presenting an access code via the mobile device 1529.

In one configuration, a resident of the premises receives a message/notification indicating arrival for delivery of the delivery mobile truck 1553 (for example, a land-based mobile drone) along with a security code for retrieval of the item being delivered at the kerbside, in response to which the resident presents the security code on a display unit disposed on a side of the delivery mobile truck 1553 that enables access to the item being delivered. For example, a pickup window on the delivery mobile truck 1553 (not shown) opens up and the item being delivered is made available for easy pickup/access by the resident after the security code presented by the resident is verified as the correct one.

The drone 1551 exchanges an access code (or other security codes, as necessary) with the drop box 1523 in order to instruct the drop box 1523 to open its lid/access assembly and provide access so that the package 1559 could be delivered.

In one configuration, a resident of the premises receives a message/notification indicating delivery of an item/package by the drone 1551 along with a security code for retrieval of the item being delivered into one of the drop boxes 1523, 1525, 1519 and a drop box identifier and a photo of the delivery being made, in response to which the resident presents the security code onto a display unit disposed on a side of the drop box (for example on the top lid of the drop box 1523) that enables pickup/access of the item delivered after verification of the security code. For example, an access control lid on the drop box 1523 (not shown) opens up and the item delivered is made available for easy pickup/access by the resident after the security code presented by the resident is verified as being the correct one.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A window drop box supporting a delivery of an item by a drone to a building via a window frame, the window drop box comprising:
a retractable drawer element sized for mounting within the window frame, the retractable drawer element having both an extended position for receiving the item from the drone outside of the building and a retracted position for holding the item within the building;
wireless communication circuitry configured to support secure communication with the drone; and
processing circuitry, after evaluating the secure communication with the drone to confirm delivery authorization, directs the retractable drawer element to the extended position to receive the item from the drone, and, after receiving the item, the processing circuitry directs the retractable drawer element containing the item to the retracted position within the building.

2. The window drop box of claim 1 wherein the processing circuitry directs the retractable drawer element containing the item to open up for easy withdrawal of the item.

3. The window drop box of claim 1 wherein the processing circuitry directs the drone to approach it along a predetermined path.

4. The window drop box of claim 1 wherein the processing circuitry communicates a notification indicating receipt of the item when the drone has delivered the item.

5. The window drop box of claim 4 wherein the notification comprises a digital image taken by a camera disposed inside the retractable drawer element.

6. The window drop box of claim 1 wherein the processing circuitry directs the drone to deliver the item at an alternate drop box when the window drop box is determined to already contain a previously delivered item.

7. A delivery drop box supporting deliveries by a drone, the delivery drop box comprising:
a container element configured to both accept a delivery item and secure the delivery item after the acceptance;
wireless communication circuitry configured to support secure communication with the drone; and
processing circuitry, after evaluating the secure communication with the drone to confirm delivery authorization, directs the container element to accept the delivery item from the drone, and, after receiving the delivery item, the processing circuitry directs the securing of the delivery item by the container element.

8. The delivery drop box of claim 7 wherein the processing circuitry directs the container element containing the delivery item to open up for easy withdrawal of the delivery item.

9. The delivery drop box of claim 7 wherein the processing circuitry directs the drone to approach it along a predetermined path.

10. The delivery drop box of claim 7 wherein the processing circuitry communicates a notification indicating receipt of the delivery item when the drone has delivered the delivery item.

11. The delivery drop box of claim 10 wherein the notification comprises a digital image taken by a camera disposed inside or on top of the container element.

12. The delivery drop box of claim 7 wherein the processing circuitry directs the drone to deliver the delivery item at an alternate drop box when the delivery drop box is determined to already contain a previously-delivered item.

13. The delivery drop box of claim 7 wherein the processing circuitry informs the drone that it cannot accommodate the delivery item being delivered.

14. A secure drop box located at a delivery site supporting a delivery of an item, the secure drop box comprising:
a container portion configured to receive the item;
an access assembly, associated with the container portion, controls access to the container portion;
processing circuitry, only after confirming delivery authorization, directs the access assembly to provide access to the container portion to receive the item, and, after receiving the item, the processing circuitry directs the access assembly to secure the item in the container portion; and
the processing circuitry, only after confirming receiver authorization, directs the access assembly to provide access to the container portion to remove the item.

15. The secure drop box of claim 14 wherein the processing circuitry directs the container portion containing the item to open up for easy withdrawal of the item.

16. The secure drop box of claim 14 wherein the processing circuitry directs a drone to approach it along a predetermined path.

17. The secure drop box of claim 14 wherein the processing circuitry communicates a notification indicating receipt of the item when a drone has delivered the item.

18. The secure drop box of claim 17 wherein notification comprises a digital image taken by a camera disposed inside or on top of the container portion.

19. The secure drop box of claim 14 wherein the processing circuitry directs a drone to deliver the item at an alternate drop box when the secure drop box is determined to already contain a previously-delivered item.

20. The secure drop box of claim 14 wherein the processing circuitry informs the drone that it cannot accommodate the item being delivered.
